(19) United States
(12) Patent Application Publication
(10) Pub. No.: US 2022/0264142 A1
(43) Pub. Date: Aug. 18, 2022

(54) IMAGE DECODING APPARATUS, IMAGE CODING APPARATUS, AND IMAGE DECODING METHOD

(71) Applicant: Sharp Kabushiki Kaisha, Sakai City, Osaka (JP)

(72) Inventors: Tomonori HASHIMOTO, Sakai City (JP); Eiichi SASAKI, Sakai City (JP); Tomohiro IKAI, Sakai City (JP); Tomoko AONO, Sakai City (JP)

(21) Appl. No.: 17/627,900

(22) PCT Filed: Jul. 21, 2020
(86) PCT No.: PCT/JP2020/028249

§ 371 Date: Jan. 18, 2022

(30) Foreign Application Priority Data
Jul. 24, 2019 (JP) 2019-135746

(51) Int. Cl. H04N 19/52; H04N 19/70

(52) U.S. Cl. CPC H04N 19/52; H04N 19/70

(57) ABSTRACT

An image decoding apparatus is provided that selectively uses a merge mode in a case that an MMVD mode is not available, thus achieving high coding efficiency. The image decoding apparatus includes a parameter decoder, and in a case that a regular merge flag indicates a regular merge mode, checks a flag indicating whether an MMVD prediction signalled in a sequence parameter set or the like is available, and in a case that the MMVD prediction is not available, decodes motion vector information obtained from a merge candidate.

### TECHNICAL FIELD

The embodiments of the present invention relate to a prediction image generation apparatus, a video decoding apparatus, and a video coding apparatus.

### BACKGROUND ART

A video coding apparatus which generates coded data by coding a video, and a video decoding apparatus which generates decoded images by decoding the coded data are used for efficient transmission or recording of videos.

Specific video coding schemes include, for example, H.264/AVC and High-Efficiency Video Coding (HEVC), and the like.

In such a video coding scheme, images (pictures) constituting a video are managed in a hierarchical structure including slices obtained by splitting an image, coding tree units (CTUs) obtained by splitting a slice, units of coding (coding units; which will be referred to as CUs) obtained by splitting a coding tree unit, and transform units (TUs) obtained by splitting a coding unit, and are coded/decoded for each CU.

In such a video coding scheme, usually, a prediction image is generated based on a local decoded image that is obtained by coding/decoding an input image (a source image), and prediction errors (which may be referred to also as “difference images” or “residual images”) obtained by subtracting the prediction image from the input image are coded. Generation methods of prediction images include an inter-picture prediction (inter prediction) and an intra-picture prediction (intra prediction).

Non-Patent Document 1 discloses a technique in which a regular merge flag is introduced and in which an inter prediction mode from coded data is selected separately from 1) a group of a merge mode and a merge plus distance mode (MMVD mode), and 2) a group of an intra-intermode (CIIP mode) and a triangle mode.

### CITATION LIST

### Non Patent Literature

NPL 1: “Versatile Video Coding (Draft 6),” JVET-O2001-v9, Joint Video Exploration Team (JVET) of ITU-T SG 16 WP 3 and ISO/IEC JTC 1/SC 29/WG 11
NPL 2: “Non-CE4: Merge mode signalling overhead reduction,”, JVET-O0309-v3, Joint Video Exploration Team (JVET) of ITU-T SG 16 WP 3 and ISO/IEC JTC 1/SC 29/WG 11, 2019 Jul. 22

### SUMMARY OF INVENTION

### Technical Problem

NPL 1 involves a problem in that in a case that an MMVD mode is not available, few choices for merge candidates are present, reducing coding efficiency.

### Solution to Problem

In order to solve the above-described problem, an aspect of the present invention provides an image decoding apparatus for decoding a parameter for generating a prediction image, the image decoding apparatus including a parameter decoder configured to decode, from merge data, a regular merge flag indicating whether a regular merge mode is used in inter prediction, wherein the parameter decoder checks a flag, signalled in a sequence parameter set, indicating whether or not a motion vector for a merge candidate is enabled in a case that the regular merge flag indicates that the regular merge mode is used for inter prediction, decodes an MMVD merge flag indicating whether or not the motion vector for the merge candidate is used to generate an inter prediction parameter of a target coding unit in a case that a value of the flag is one, and decodes a merge index which is an index of a merge candidate list by using the MMVD merge flag.

In the image decoding apparatus according to an aspect of the present invention, the merge index is decoded in a case that the MMVD merge flag indicates that the motion vector for the merge candidate is not used to generate the inter prediction parameter and that the number of merge candidates is greater than one.

In the image decoding apparatus according to an aspect of the present invention, in a case that a value of the MMVD merge flag is zero, a value of the merge index is inferred to be 0.

An aspect of the present invention provides an image coding apparatus for coding a parameter for generating a prediction image, the image coding apparatus including a parameter coder configured to code, from merge data, a regular merge flag indicating whether a regular merge mode is used for inter prediction, wherein the parameter coder checks a flag, signalled in a sequence parameter set, indicating whether a motion vector for a merge candidate is enabled in a case that the regular merge flag indicates that the regular merge mode is used for inter prediction, codes an MMVD merge flag indicating whether the motion vector for the merge candidate is used to generate an inter prediction parameter for a target coding unit in a case that a value of the flag is one, and codes a merge index corresponding to an index for a merge candidate list by using the MMVD merge flag.

An aspect of the present invention provides an image decoding method for decoding a parameter for generating a prediction image, the image decoding method at least including the steps of: decoding, from merge data, a regular merge flag indicating whether a regular merge mode is used for inter prediction; checking a flag, signalled in a sequence parameter set, indicating whether a motion vector for a merge candidate is enabled in a case that the regular merge flag indicates that the regular merge mode is used for inter prediction; decoding an MMVD merge flag indicating whether the motion vector for the merge candidate is used to generate an inter prediction parameter for a target coding unit in a case that a value of the flag is one; and decoding a merge index corresponding to an index for a merge candidate list by using the MMVD merge flag.

### Advantageous Effects of Invention

According to an aspect of the present invention, the above-described problem can be solved.

### BRIEF DESCRIPTION OF DRAWINGS

FIG. 1 is a schematic diagram illustrating a configuration of an image transmission system according to the present embodiment.

FIG. 2 is a diagram illustrating configurations of a transmitting apparatus equipped with a video coding apparatus and a receiving apparatus equipped with a video decoding apparatus according to the present embodiment. (a) thereof illustrates the transmitting apparatus equipped with the video coding apparatus, and (b) thereof illustrates the receiving apparatus equipped with the video decoding apparatus.

FIG. 3 is a diagram illustrating configurations of a recording apparatus equipped with the video coding apparatus and a reconstruction apparatus equipped with the video decoding apparatus according to the present embodiment. (a) thereof illustrates the recording apparatus equipped with the video coding apparatus, and (b) thereof illustrates the reconstruction apparatus equipped with the video decoding apparatus.

FIG. 4 is a diagram illustrating a hierarchical structure of data of a coding stream.

FIG. 5 is a diagram illustrating an example of split of a CTU.

FIG. 6 is a conceptual diagram illustrating an example of reference pictures and reference picture lists.

FIG. 7 is a schematic diagram illustrating a configuration of a video decoding apparatus.

FIG. 8 is a flowchart illustrating general operation of the video decoding apparatus.

FIG. 9 is a schematic diagram illustrating a configuration of an inter prediction parameter derivation unit.

FIG. 10 is a schematic diagram illustrating a configuration of a merge prediction parameter derivation unit and an AMVP prediction parameter derivation unit.

FIG. 11 is a schematic diagram illustrating a configuration of an inter prediction image generation unit.

FIG. 12 is a block diagram illustrating a configuration of a video coding apparatus.

FIG. 13 is a schematic diagram illustrating a configuration of an inter prediction parameter coder.

FIG. 14 is a diagram illustrating MMVD.

FIG. 15 is a diagram illustrating a flow of inter-prediction prediction mode derivation processing.

FIG. 16 is a diagram illustrating a syntax indicating selection processing for a prediction mode according to the present embodiment.

FIG. 17 is a diagram illustrating a regular merge flag.

FIG. 18 is a flowchart illustrating a flow of prediction mode selection processing in the video decoding apparatus.

FIG. 19 is a flowchart illustrating a flow of the prediction mode selection processing in the video decoding apparatus.

FIG. 20 is a diagram illustrating a syntax indicating the prediction mode selection processing according to the present embodiment.

### DESCRIPTION OF EMBODIMENTS

### First Embodiment

Hereinafter, an embodiment of the present invention will be described with reference to the drawings.

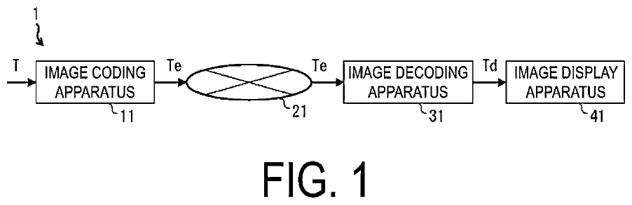

FIG. 1 is a schematic diagram illustrating a configuration of an image transmission system 1 according to the present embodiment.

The image transmission system 1 is a system in which a coding stream obtained by coding a coding target image is transmitted, the transmitted coding stream is decoded, and thus an image is displayed. The image transmission system 1 includes a video coding apparatus (image coding apparatus) 11, a network 21, a video decoding apparatus (image decoding apparatus) 31, and a video display apparatus (image display apparatus) 41.

An image T is input to the video coding apparatus 11.

The network 21 transmits a coding stream Te generated by the video coding apparatus 11 to the video decoding apparatus 31. The network 21 is the Internet, a Wide Area Network (WAN), a Local Area Network (LAN), or a combination thereof. The network 21 is not necessarily limited to a bidirectional communication network, and may be a unidirectional communication network configured to transmit broadcast waves of digital terrestrial television broadcasting, satellite broadcasting of the like. Furthermore, the network 21 may be substituted by a storage medium in which the coding stream Te is recorded, such as a Digital Versatile Disc (DVD: trade name) or a Blue-ray Disc (BD: trade name)

The video decoding apparatus 31 decodes each of the coding streams Te transmitted from the network 21 and generates one or multiple decoded images Td.

The video display apparatus 41 displays all or part of one or multiple decoded images Td generated by the video decoding apparatus 31. For example, the video display apparatus 41 includes a display device such as a liquid crystal display and an organic Electro-Luminescence (EL) display. Forms of the display include a stationary type, a mobile type, an HMD type, and the like. In addition, in a case that the video decoding apparatus 31 has a high processing capability, an image having high image quality is displayed, and in a case that the apparatus has a lower processing capability, an image which does not require high processing capability and display capability is displayed.

### Operator

Operators used in the present specification will be described below.

>> is a right bit shift, << is a left bit shift, & is a bitwise AND, | is a bitwise OR, |= is an OR assignment operator, and ∥ indicates a logical sum.

x?y:z is a ternary operator to take y in a case that x is true (other than 0) and take z in a case that x is false (0).

Clip3(a, b, c) is a function to clip c in a value equal to or greater than a and less than or equal to b, and a function to return a in a case that c is less than a (c<a), return b in a case that c is greater than b (c>b), and return c in other cases (provided that a is less than or equal to b (a<=b)).

abs (a) is a function that returns the absolute value of a.

Int (a) is a function that returns the integer value of a.

floor (a) is a function that returns the maximum integer equal to or less than a.

ceil (a) is a function that returns the minimum integer equal to or greater than a.

a/d represents division of a by d (round down decimal places).

### Structure of Coding Stream Te

Prior to the detailed description of the video coding apparatus 11 and the video decoding apparatus 31 according to the present embodiment, a data structure of the coding stream Te generated by the video coding apparatus 11 and decoded by the video decoding apparatus 31 will be described.

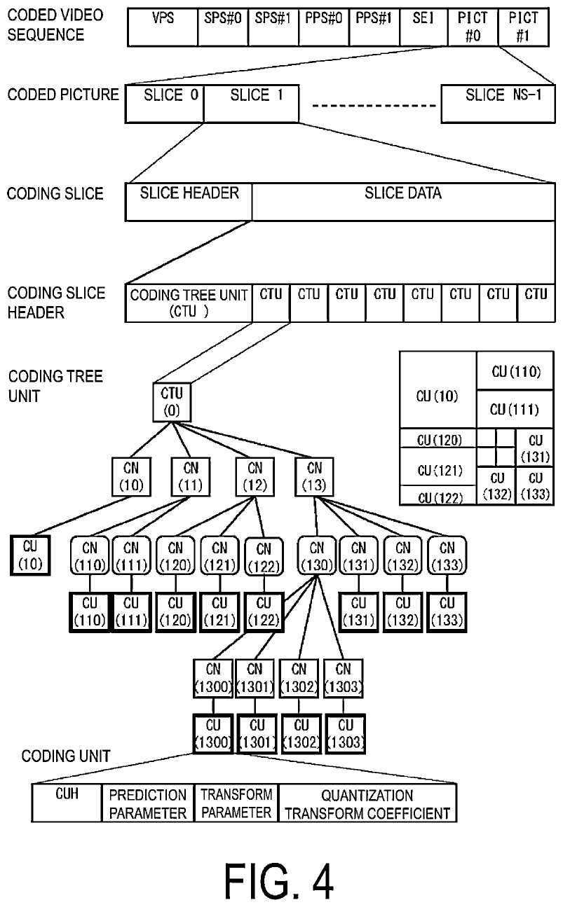

FIG. 4 is a diagram illustrating a hierarchical structure of data of the coding stream Te. The coding stream Te includes a sequence and multiple pictures constituting the sequence illustratively. (a) to (f) of FIG. 4 are diagrams illustrating a coded video sequence defining a sequence SEQ, a coded picture prescribing a picture PICT, a coding slice prescribing a slice S, a coding slice data prescribing slice data, a coding tree unit included in the coding slice data, and a coding unit included in the coding tree unit, respectively.

### Coded Video Sequence

In the coded video sequence, a set of data referenced by the video decoding apparatus 31 to decode the sequence SEQ to be processed is defined. As illustrated in FIG. 4, the sequence SEQ includes a Video Parameter Set, a Sequence Parameter Set SPS, a Picture Parameter Set PPS, an Adaptation Parameter Set (APS), a picture PICT, and Supplemental Enhancement Information SEI.

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referenced by the video decoding apparatus 31 to decode a target sequence is defined. For example, a width and a height of a picture are defined. Note that multiple SPSs may exist. In that case, any of the multiple SPSs is selected from the PPS.

In the picture parameter set PPS, a set of coding parameters referenced by the video decoding apparatus 31 to decode each picture in a target sequence is defined. For example, a reference value (pic_init_qp_minus26) of a quantization step size used for decoding of a picture and a flag (weighted_pred_flag) indicating an application of a weight prediction are included. Note that multiple PPSs may exist. In that case, any of the multiple PPSs is selected from each picture in a target sequence.

### Coded Picture

In the coded picture, a set of data referenced by the video decoding apparatus 31 to decode the picture PICT to be processed is defined. As illustrated in FIG. 4, the picture PICT includes a slice 0 to a slice NS−1 (NS is the total number of slices included in the picture PICT).

Note that in a case that it is not necessary to distinguish each of the slice 0 to the slice NS−1 below, subscripts of reference signs may be omitted. In addition, the same applies to other data with subscripts included in the coding stream Te which will be described below.

### Coding Slice

In the coding slice, a set of data referenced by the video decoding apparatus 31 to decode the slice S to be processed is defined. As illustrated in FIG. 4, the slice includes a slice header and slice data.

The slice header includes a coding parameter group referenced by the video decoding apparatus 31 to determine a decoding method for a target slice. Slice type specification information (slice_type) indicating a slice type is one example of a coding parameter included in the slice header.

Examples of slice types that can be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like. Note that the inter prediction is not limited to a uni-prediction and a bi-prediction, and the prediction image may be generated by using a larger number of reference pictures. Hereinafter, in a case of being referred to as the P or B slice, a slice that includes a block in which the inter prediction can be used is indicated.

Note that the slice header may include a reference to the picture parameter set PPS (pic_parameter_set_id).

### Coding Slice Data

In the coding slice data, a set of data referenced by the video decoding apparatus 31 to decode the slice data to be processed is defined. The slice data includes a CTU as illustrated in FIG. 4(d). The CTU is a block of a fixed size (for example, 64×64) constituting a slice, and may be called a Largest Coding Unit (LCU).

### Coding Tree Unit

In FIG. 4, a set of data is defined that is referenced by the video decoding apparatus 31 to decode the CTU to be processed. The CTU is split into coding units CUs, each of which is a basic unit of coding processing, by a recursive Quad Tree split (QT split), Binary Tree split (BT split), or Ternary Tree split (TT split). The BT split and the TT split are collectively referred to as a Multi Tree split (MT split). Nodes of a tree structure obtained by recursive quad tree splits are referred to as Coding Nodes. Intermediate nodes of a quad tree, a binary tree, and a ternary tree are coding nodes, and the CTU itself is also defined as the highest coding node.

The CT includes, as CT information, a CU split flag (split_cu_flag) indicating whether or not to perform a CT split, a QT split flag (qt_split_cu_flag) indicating whether or not to perform a QT split, an MT split flag (mtt_split_cu_flag) indicating the presence or absence of an MT split, an MT split direction (mtt_split_cu_vertical_flag) indicating a split direction of an MT split, and an MT split type (mtt_split_cu_binary_flage) indicating a split type of the MT split. split_cu_flag, qt_split_cu_flag, mtt_split_cu_flag, mtt_split_cu_vertical_flag, and mtt_split_cu_binary_flag are transmitted for each coding node.

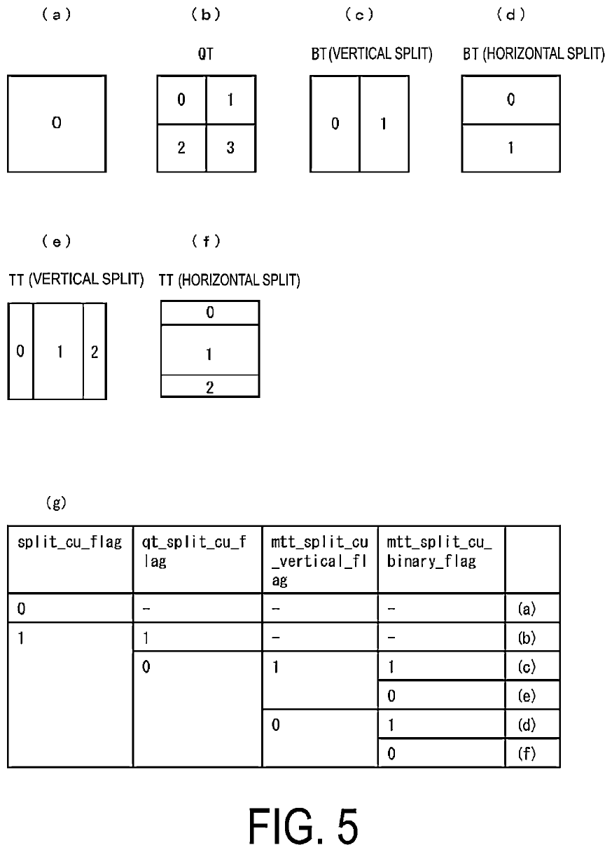

In a case that split_cu_flag is 1 and that qt_split_cu_flag is 1, the coding node is split into four coding nodes (FIG. 5(b)).

In a case that split_cu_flag is 0, the coding node is not split and has one CU as a node (FIG. 5(a)). The CU is an end node of the coding nodes and is not split any further. The CU is a basic unit of coding processing.

In a case that split_cu_flag is 1 and that qt_split_cu_flag is 0, the coding node is subjected to the MT split as described below. In a case of mtt_split_cu_binary_flag being 1, the coding node is horizontally split into two coding nodes in a case that mtt_split_cu_vertical_flag is 0 (FIG. 5(d)), and the coding node is vertically split into two coding nodes in a case that mtt_split_cu_vertical_flag is 1 (FIG. 5(c)). In a case of mtt_split_cu_binary_flag being 0, the coding node is horizontally split into three coding nodes in a case that mtt_split_cu_vertical_flag is 0 (FIG. 5(f)), and the coding node is vertically split into three coding nodes in a case that mtt_split_cu_vertical_flag is 1 (FIG. 5(e)). These are illustrated in FIG. 5(g).

Furthermore, in a case that a size of the CTU is 64×64 pixels, a size of the CU may take any of 64×64 pixels, 64×32 pixels, 32×64 pixels, 32×32 pixels, 64×16 pixels, 16×64 pixels, 32×16 pixels, 16×32 pixels, 16×16 pixels, 64×8 pixels, 8×64 pixels, 32×8 pixels, 8×32 pixels, 16×8 pixels, 8×16 pixels, 8×8 pixels, 64×4 pixels, 4×64 pixels, 32×4 pixels, 4×32 pixels, 16×4 pixels, 4×16 pixels, 8×4 pixels, 4×8 pixels, and 4×4 pixels.

Different trees may be used between luma and chroma. The type of the tree is represented by treeType. For example, in a case that a common tree is used for luma (Y, cIdx=0) and chroma (Cb/Cr, cIdx=1,2), a common single tree is represented by treeType=SINGLE_TREE. In a case that two different trees (DUAL tree) are used for luma and chroma, the tree of luma is represented by treeType=DUAL_TREE_LUMA, and the tree of chroma is represented by treeType=DUAL_TREE_CHROMA.

### Coding Unit

In FIG. 4, a set of data referenced by the video decoding apparatus 31 to decode the coding unit to be processed is defined. Specifically, the CU includes a CU header CUH, a prediction parameter, a transform parameter, a quantization transform coefficient, and the like. In the CU header, a prediction mode and the like are defined.

There are cases that the prediction processing is performed in units of CU or performed in units of sub-CU in which the CU is further split. In a case that the sizes of the CU and the sub-CU are equal to each other, the number of sub-CUs in the CU is one. In a case that the CU is larger in size than the sub-CU, the CU is split into sub-CUs. For example, in a case that the CU has a size of 8×8, and the sub-CU has a size of 4×4, the CU is split into four sub-CUs which include two horizontal splits and two vertical splits.

There are two types of predictions (prediction modes), which are intra prediction and inter prediction. The intra prediction refers to a prediction in an identical picture, and the inter prediction refers to prediction processing performed between different pictures (for example, between pictures of different display times, and between pictures of different layer images).

Transform and quantization processing is performed in units of CU, but the quantization transform coefficient may be subjected to entropy coding in units of sub-block such as 4×4.

### Prediction Parameter

A prediction image is derived by prediction parameters accompanying a block. The prediction parameters include prediction parameters for intra prediction and inter prediction.

The prediction parameters for inter prediction will be described below. The inter prediction parameters include prediction list utilization flags predFlagL0 and predFlagL1, reference picture indexes refIdxL0 and refIdxL1, and motion vectors mvL0 and mvL1. predFlagL0 and predFlagL1 are flags indicating whether reference picture lists (L0 list and L1 list) are used, and in a case that the value of each of the flags is 1, a corresponding reference picture list is used. Note that, in a case that the present specification mentions “a flag indicating whether or not XX”, a flag being other than 0 (for example, 1) assumes a case of XX, and a flag being 0 assumes a case of not XX, and 1 is treated as true and 0 is treated as false in a logical negation, a logical product, and the like (hereinafter, the same is applied). However, other values can be used for true values and false values in real apparatuses and methods.

For example, syntax elements to derive the inter prediction parameters include an affine flag affine_flag, a merge flag merge_flag, a merge index merge_idx, and an MMVD flag mmvd_flag that are used in the merge mode, an inter prediction indicator inter_pred_idc and a reference picture index refIdxLX that are used to select a reference picture in the AMVP mode, a prediction vector index mvp_LX_idx, a difference vector mvdLX, and a motion vector precision mode amvr_mode that are used to derive a motion vector.

### Reference Picture List

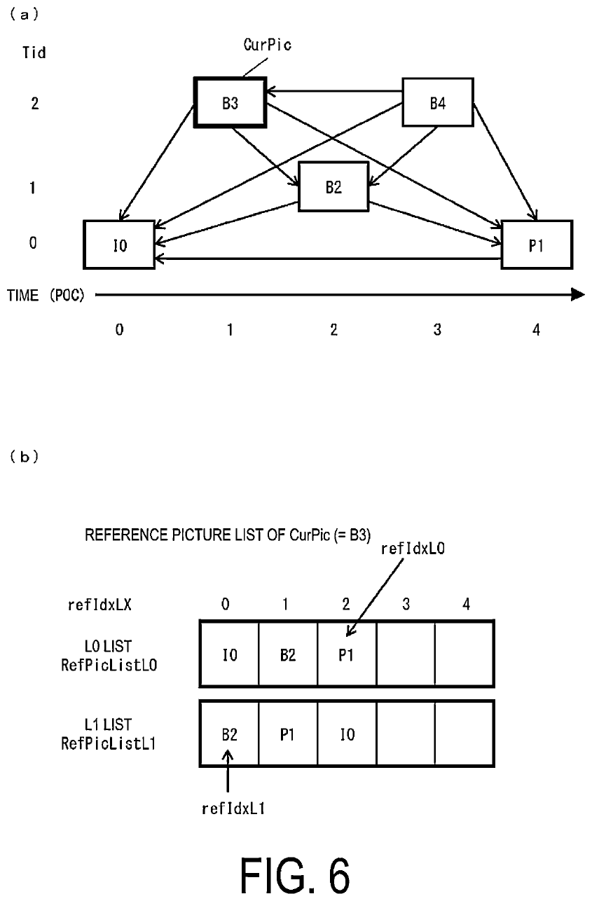

A reference picture list is a list including reference pictures stored in a reference picture memory 306. FIG. 6 is a conceptual diagram illustrating an example of reference pictures and reference picture lists. In FIG. 6(a), a rectangle indicates a picture, an arrow indicates a reference relationship of a picture, a horizontal axis indicates time, each of I, P, and B in a rectangle indicates an intra-picture, a uni-prediction picture, a bi-prediction picture, and a number in a rectangle indicates a decoding order. As illustrated, the decoding order of the pictures is I0, P1, B2, B3, and B4, and the display order is I0, B3, B2, B4, and P1. FIG. 6(b) illustrates an example of reference picture lists of the picture B3 (target picture). The reference picture list is a list to represent a candidate of a reference picture, and one picture (slice) may include one or more reference picture lists. In the illustrated example, the target picture B3 includes two reference picture lists, i.e., an L0 list RefPicList0 and an L1 list RefPicList1. For individual CUs, which picture in a reference picture list RefPicListX (X=0 or 1) is actually referenced is specified with refIdxLX. The diagram illustrates an example of refIdxL0=2, refIdxL1=0. Note that LX is a description method used in a case of not distinguishing an L0 prediction and an L1 prediction, and in the following description, distinguishes parameters for the L0 list and parameters for the L1 list by replacing LX with L0 and L1.

### Merge Prediction and AMVP Prediction

A decoding (coding) method for prediction parameters include a merge prediction (merge) mode and an Advanced Motion Vector Prediction (AMVP) mode, and merge_flag is a flag to identify the modes. The merge prediction mode is a mode to use to derive prediction parameters for a target block from prediction parameters for neighboring blocks already processed, or the like, without including, in the coded data, a prediction list utilization flag predFlagLX, the reference picture index refIdxLX, and a motion vector mvLX in coded data. The AMVP mode is a mode in which inter_pred_idc, refIdxLX, and mvLX are included in the coded data. Note that, mvLX is coded as mvp_LX_idx identifying a prediction vector mvpLX and a difference vector mvdLX. In addition to the merge prediction mode, an affine prediction mode and an MMVD prediction mode may be available.

inter_pred_idc is a value indicating the types and number of reference pictures, and takes any value of PRED_L0, PRED_L1, or PRED_BI. PRED_L0 and PRED_L1 indicate uni-predictions which use one reference picture managed in the L0 list and one reference picture managed in the L1 list, respectively. PRED_BI indicates a bi-prediction which uses two reference pictures managed in the L0 list and the L1 list.

merge_idx is an index to indicate which prediction parameter is used as a prediction parameter for the target block, among prediction parameter candidates (merge candidates) derived from blocks of which the processing is completed.

### Motion Vector

mvLX indicates a shift amount between blocks in two different pictures. A prediction vector and a difference vector related to mvLX are respectively referred to as mvpLX and mvdLX.

Inter Prediction Indicator inter_pred_idc and Prediction List Utilization Flag predFlagLX

A relationship between inter_pred_idc and predFlagL0 and predFlagL1 is as follows, and inter_pred_idc, predFlagL0, and predFlagL1 can be converted into one another.

inter_pred_idc=(predFlagL1<<1)+predFlagL0

predFlagL0=inter_pred_idc&1

predFlagL1=inter_pred_idc>>1

Note that the inter prediction parameters may use a prediction list utilization flag or may use an inter prediction indicator. A determination using a prediction list utilization flag may be replaced with a determination using an inter prediction indicator. On the contrary, a determination using an inter prediction indicator may be replaced with a determination using a prediction list utilization flag.

Determination of Bi-Prediction biPred

A flag biPred for identifying a bi-prediction can be derived from whether two prediction list utilization flags are both 1. For example, the derivation can be performed by the following equation.

biPred=(predFlagL0==1&&predFlagL1==1)

Alternatively, biPred can be also derived from whether the inter prediction indicator is a value indicating the use of two prediction lists (reference pictures). For example, the derivation can be performed by the following equation.

biPred=(inter_pred_idc=PRED_BI)?1:0

### Intra Prediction Parameter

The prediction parameters for intra prediction will be described below. The intra prediction parameters include a luma prediction mode IntraPredModeY and a chroma prediction mode IntraPredModeC. For example, planar prediction (0), DC prediction (1), and Angular prediction (value other than 0 and 1) are available. Furthermore, for chroma, a CCLM mode (81 to 83) may be added.

### Configuration of Video Decoding Apparatus

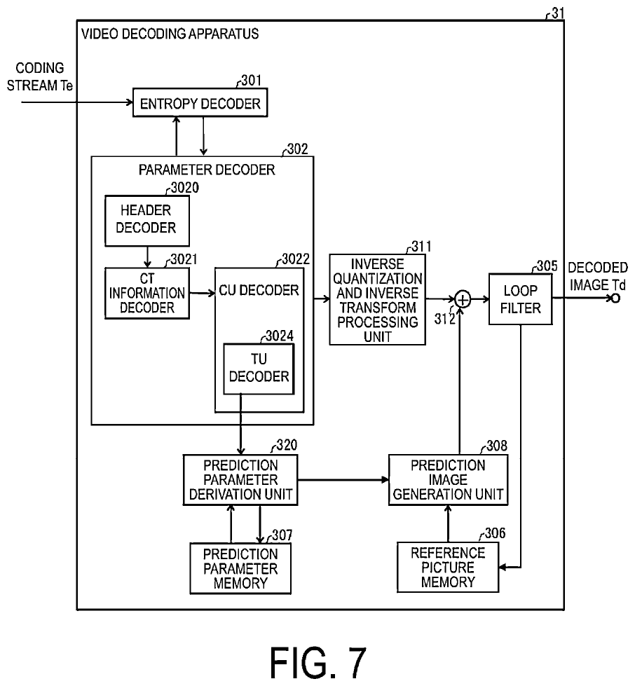

The configuration of the video decoding apparatus 31 (FIG. 7) according to the present embodiment will be described.

The video decoding apparatus 31 includes an entropy decoder 301, a parameter decoder (a prediction image decoding apparatus) 302, a loop filter 305, a reference picture memory 306, a prediction parameter memory 307, a prediction image generation unit (prediction image generation apparatus) 308, an inverse quantization and inverse transform processing unit 311, an addition unit 312, and a prediction parameter derivation unit 320. Note that a configuration in which the loop filter 305 is not included in the video decoding apparatus 31 may be used in accordance with the video coding apparatus 11 described later.

The parameter decoder 302 further includes a header decoder 3020, a CT information decoder 3021, and a CU decoder 3022 (prediction mode decoder), and the CU decoder 3022 further includes a TU decoder 3024. These may be collectively referred to as a decoding module. The header decoder 3020 decodes, from coded data, parameter set information such as the VPS, the SPS, the PPS, and an APS, and a slice header (slice information). The CT information decoder 3021 decodes a CT from coded data. The CU decoder 3022 decodes a CU from coded data. In a case that a TU includes a prediction error, the TU decoder 3024 decodes QP update information (quantization correction value) and quantization prediction error (residual_coding) from coded data.

In the mode other than the skip mode (skip_mode==0), the TU decoder 3024 decodes QP update information and quantization prediction error from coded data. More specifically, the TU decoder 3024 decodes, in a case of skip_mode==0, a flag cu_cbp indicating whether a quantization prediction error is included in the target block, and decodes the quantization prediction error in a case that cu_cbp is 1. In a case that cu_cbp is not present in the coded data, the TU decoder 3024 derives cu_cbp as 0.

The TU decoder 3024 decodes an index mts_idx indicating a transform basis from the coded data. The TU decoder 3024 decodes, from the coded data, an index stIdx indicating the use of a secondary transformation and the transform basis. stIdx being 0 indicates non-application of the secondary transformation, stIdx being 1 indicates transformation of one of a set (pair) of secondary transform bases, and stIdx being 2 indicates transformation of the other of the pair of secondary transform bases.

The TU decoder 3024 may decode a sub-block transformation flag cu_sbt_flag. In a case that cu_sbt_flag is 1, the CU is split into multiple sub-blocks, and for only one particular sub-block, the residual is decoded. Furthermore, the TU decoder 3024 may decode the flag cu_sbt_quad_flag indicating whether the number of sub-blocks is 4 or 2, cu_sbt_horizontal_flag indicating a split direction, and cu_sbt_pos_flag indicating a sub-block including a non-zero transform coefficient.

The prediction image generation unit 308 includes an inter prediction image generation unit 309 and an intra prediction image generation unit 310.

The prediction parameter derivation unit 320 includes an inter prediction parameter derivation unit 303 and an intra prediction parameter derivation unit 304.

Furthermore, an example in which a CTU and a CU are used as units of processing is described below, but the processing is not limited to this example, and processing in units of sub-CU may be performed. Alternatively, the CTU and the CU may be replaced with a block, the sub-CU may be replaced with by a sub-block, and processing may be performed in units of blocks or sub-blocks.

The entropy decoder 301 performs entropy decoding on the coding stream Te input from the outside and separates and decodes individual codes (syntax elements). The entropy coding includes a scheme in which syntax elements are subjected to variable length coding by using a context (probability model) that is adaptively selected according to a type of the syntax elements and a surrounding condition, and a scheme in which syntax elements are subjected to variable length coding by using a table or a calculation expression that is determined in advance. The former CABAC (Context Adaptive Binary Arithmetic Coding) stores in memory a CABAC state of the context (the type of a dominant symbol (0 or 1) and a probability state index pStateIdx indicating a probability). The entropy decoder 301 initializes all CABAC states at the beginning of a segment (tile, CTU row, or slice). The entropy decoder 301 transforms the syntax element into a binary string (Bin String) and decodes each bit of the Bin String. In a case that the context is used, a context index ctxInc is derived for each bit of the syntax element, the bit is decoded using the context, and the CABAC state of the context used is updated. Bits that do not use the context are decoded at an equal probability (EP, bypass), and the ctxInc derivation and CABAC state are omitted. The decoded syntax element includes prediction information for generating a prediction image, a prediction error for generating a difference image, and the like.

The entropy decoder 301 outputs the decoded codes to the parameter decoder 302. The decoded code is, for example, a prediction mode predMode, merge_flag, merge_idx, inter_pred_idc, refIdxLX, mVP_Lx_idx, mvdLX, amvr_mode, and the like. Which code is to be decoded is controlled based on an indication of the parameter decoder 302.

### Basic Flow of Operation

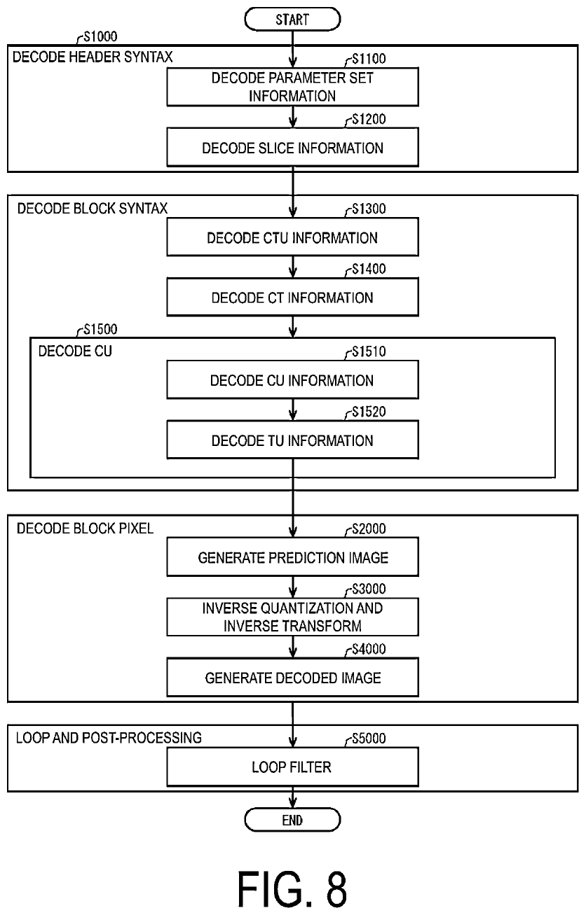

FIG. 8 is a flowchart for describing general operation performed in the video decoding apparatus 31.

(S1100: Decoding of parameter set information) The header decoder 3020 decodes parameter set information such as the VPS, the SPS, and the PPS from coded data.

(S1200: Decoding of slice information) The header decoder 3020 decodes a slice header (slice information) from the coded data.

Afterwards, the video decoding apparatus 31 repeats the processing from S1300 to S5000 for each CTU included in the target picture, and thereby derives a decoded image of each CTU.

(S1300: Decoding of CTU information) The CT information decoder 3021 decodes the CTU from the coded data.

(S1400: Decoding of CT information) The CT information decoder 3021 decodes the CT from the coded data.

(S1500: Decoding of CU) The CU decoder 3022 decodes the CU from the coded data by performing S1510 and S1520.

(S1510: Decoding of CU information) The CU decoder 3022 decodes, for example, CU information, prediction information, a TU split flag split_transform_flag, CU residual flags cbf_cb, cbf_cr, and cbf_luma from the coded data.

(S1520: Decoding of TU information) In a case that a prediction error is included in the TU, the TU decoder 3024 decodes, from the coded data, QP update information and a quantization prediction error, and transform index mts_idx. Note that the QP update information is a difference value from a quantization parameter prediction value qPpred, which is a prediction value of a quantization parameter QP.

(S2000: Generation of prediction image) The prediction image generation unit 308 generates a prediction image, based on the prediction information, for each block included in the target CU.

(S3000: Inverse quantization and inverse transform) The inverse quantization and inverse transform processing unit 311 performs inverse quantization and inverse transform processing on each TU included in the target CU.

(S4000: Generation of decoded image) The addition unit 312 generates a decoded image of the target CU by adding the prediction image supplied by the prediction image generation unit 308 and the prediction error supplied by the inverse quantization and inverse transform processing unit 311.

(S5000: Loop filter) The loop filter 305 generates a decoded image by applying a loop filter such as a deblocking filter, an SAO, and an ALF to the decoded image.

### Configuration of Inter Prediction Parameter Derivation Unit

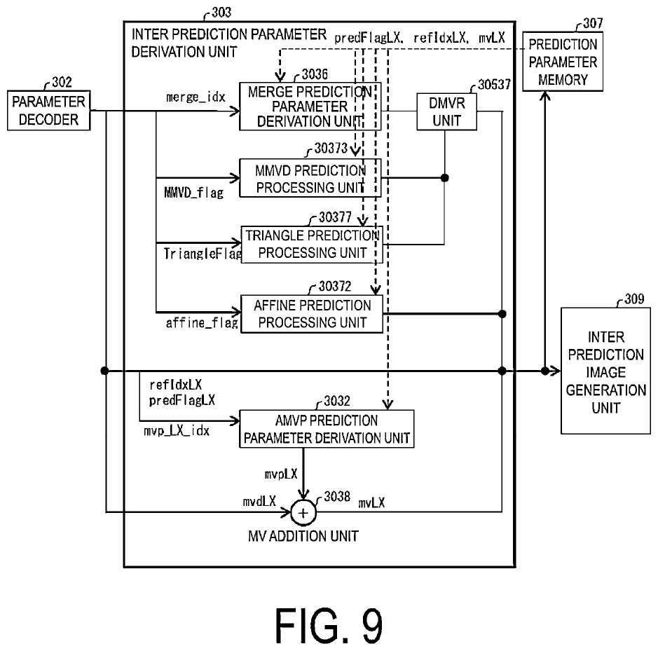

The inter prediction parameter derivation unit 303 derives an inter prediction parameter with reference to the prediction parameters stored in the prediction parameter memory 307, based on the syntax element input from the parameter decoder 302. The inter prediction parameter decoder 303 outputs the inter prediction parameter to the inter prediction image generation unit 309 and the prediction parameter memory 307. As illustrated in FIG. 9, the following are means shared by the video coding apparatus and the video decoding apparatus, and may thus be collectively referred to as a motion vector derivation unit (motion vector derivation apparatus): the inter prediction parameter derivation unit 303 and internal elements of the inter prediction parameter derivation unit 303 including an AMVP prediction parameter derivation unit 3032, a merge prediction parameter derivation unit 3036, an affine prediction processing unit 30372, and an MMVD prediction processing unit 30373, a triangle prediction processing unit 30377, a DMVR unit 30537, and an MV addition unit 3038.

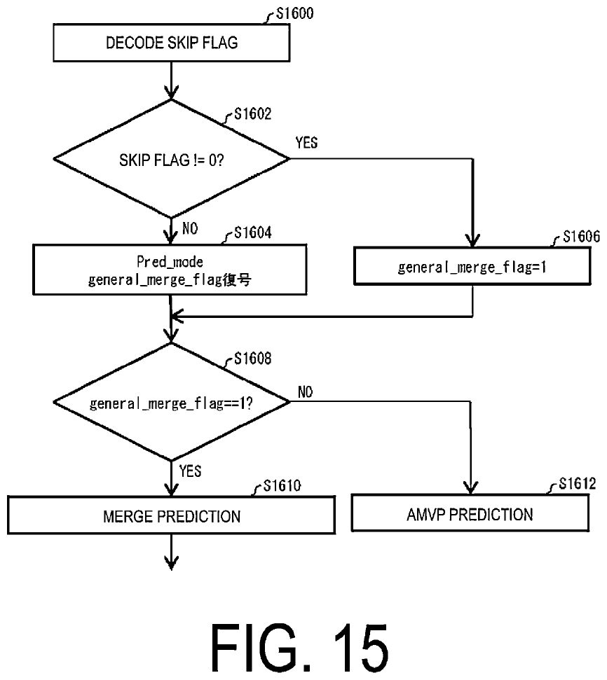

FIG. 15 is a diagram illustrating a flow of inter-prediction prediction mode derivation processing. The parameter decoder 302 decodes the skip flag (cu_skip_flag) (S1600).

The inter prediction parameter derivation unit 303 determines whether the skip flag is 0 (S1602).

In a case that the skip flag is 0, the parameter decoder 302 decodes the merge flag (general_merge_flag) (S1604). On the other hand, in a case that the skip flag is not 0, the inter prediction parameter derivation unit 303 sets the merge flag equal to 1 (S1606).

The parameter decoder 302 determines whether the merge flag is 1 (S1608).

In a case that the merge flag is 1, the parameter decoder 302 determines that the target block corresponds to a merge prediction, and derives information related to the merge prediction (S1610). In a case that the merge flag is not 1, the inter prediction parameter derivation unit 303 determines that the target block corresponds to an AMVP prediction, and derives information related to the AMVP prediction (S1612).

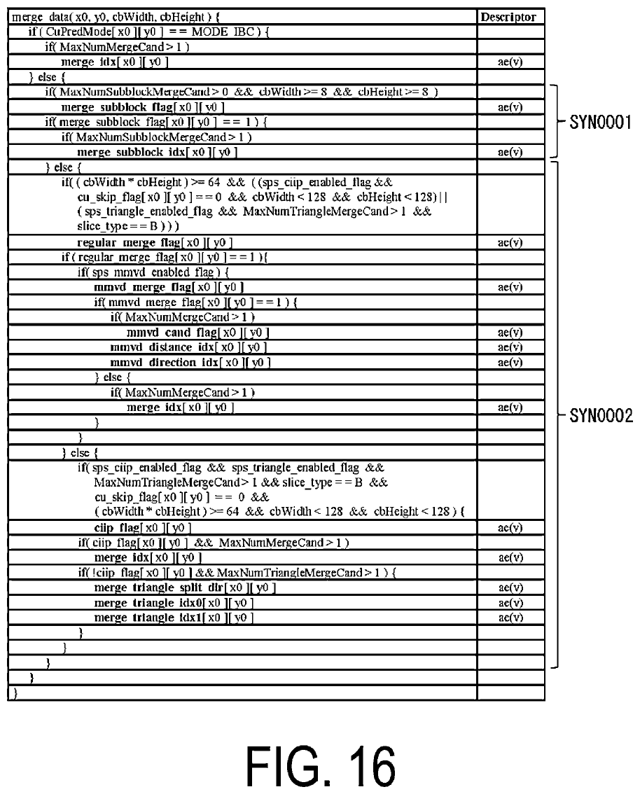

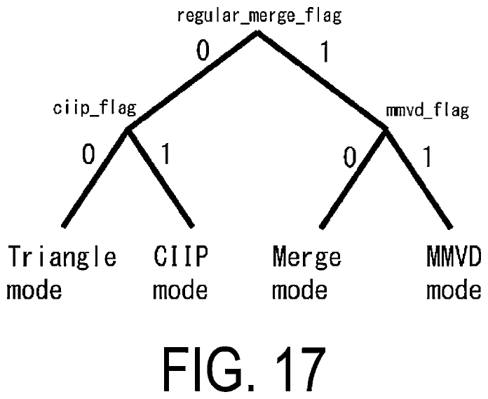

FIG. 16 illustrates a syntax of information related to the merge prediction. SYN0001 is the syntax of the merge prediction in sub-block units, and SYN0002 is the syntax of the merge prediction in block units. SYN0002 will be described using FIG. 17.

### Syntax Decoding of Regular Merge Flag

FIG. 17 is a diagram illustrating a regular merge flag (regular_merge_flag). The regular merge flag is a flag that categorizes the merge prediction in the inter prediction mode into 1) a group of a merge mode (in a narrow sense) and a merge plus distance mode (MMVD mode), and 2) a group of an intra-inter mode (CIIP mode) and a triangle mode. Multiple (four in this case) prediction modes allocated on the tree in a well-balanced manner are characterized in that an increase in bit costs is prevented, increasing coding efficiency and that the tree is prevented from being deep, reducing processing delay. The two modes in 1) may be collectively referred to as a regular merge mode.

### Embodiment 1

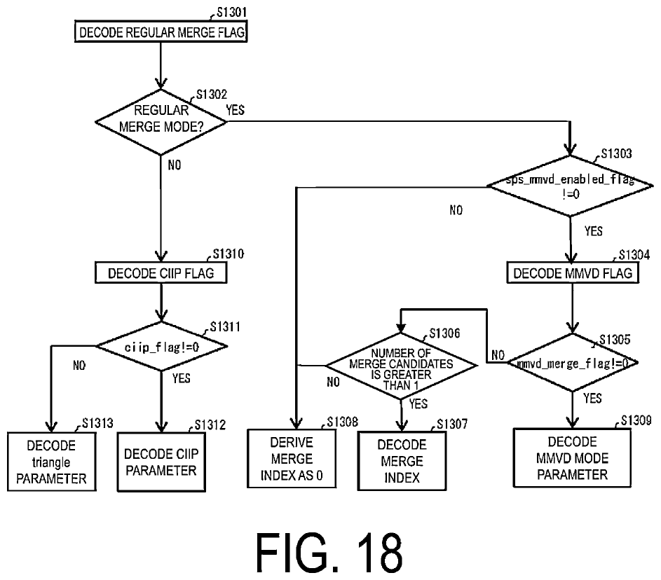

Now, a flow of prediction mode selection processing will be described with reference to FIG. 18. FIG. 18 is a flowchart illustrating a flow of prediction mode derivation processing in the parameter decoder 302 and the inter prediction parameter derivation unit 303.

The parameter decoder 302 decodes the regular_merge_flag (S1301). In a case of regular_merge_flag==1 (YES in S1302), the value of sps_mmvd_enabled_flag is checked (S1303). sps_mmvd_enabled_flag is a flag signalled by a sequence parameter set (SPS) or the like and indicating whether the MMVD prediction is available. In a case that the sps_mmvd_enabled_flag==1, in other words, the MMVD prediction is available (YES in S1303), the parameter decoder 302 decodes the MMVD flag (mmvd_merge_flag) from the coded data (S1304).

mmvd_merge_flag being 1 indicates that the MMVD mode is used to generate an inter prediction parameter for the target CU. mmvd_merge_flag being 0 indicates that the MMVD mode is not used to generate an inter prediction parameter for the target CU. In a case that the mmvd_merge_flag is not signalled, 0 is set in this flag. For example, in a case that sps_mmvd_enabled_flag==0, in other words, the MMVD prediction is not available, 0 is set in mmvd_merge_flag.

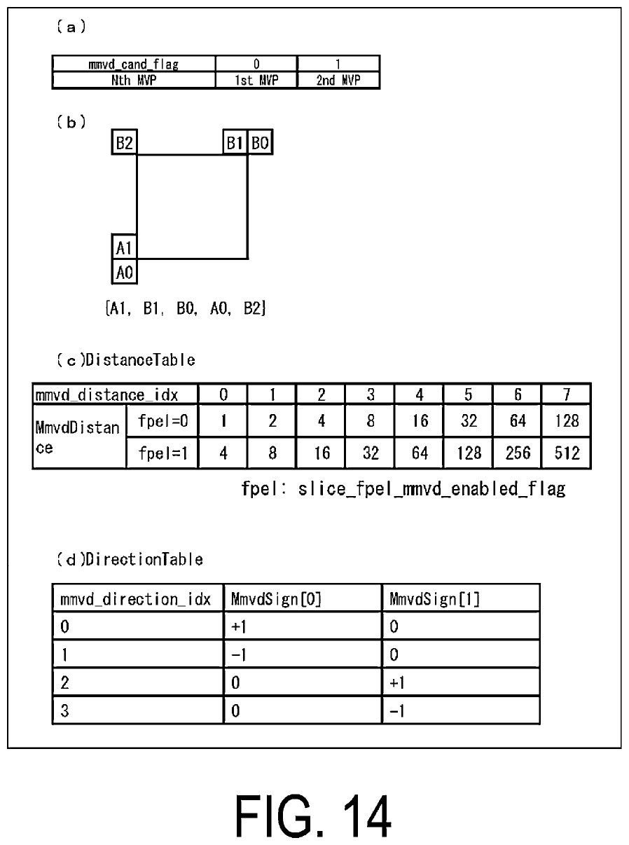

In a case that mmvd_merge_flag==1, in other words, the MMVD flag indicates the MMVD mode (YES in S1305), the parameter decoder 302 decodes parameters for the MMVD mode from the coded data (S1309). Specifically, the parameter decoder 302 decodes mmvd_cand_flag, mmvd_distance_idx, and mmvd_direction_idx. As illustrated in FIG. 14(a), mmvd_cand_flag indicates which of the first and second candidates of the merge candidate list are used for the MMVD prediction, as illustrated in FIG. 14(a). mmvd_distance_idx indicates the distance of the difference vector as illustrated in FIG. 14(c). mmvd_direction_idx indicates the direction of the difference vector as illustrated in 14(d).

In a case that the number of candidates for the MMVD prediction MaxNumMergeCand is 1 or less, the inter prediction parameter derivation unit 303 may set mmvd_cand_flag equal to 0.

In a case that the mmvd_merge_flag==0, in other words, the MMVD flag does not indicate the MMVD mode (NO in S1305) and that the number of merge candidates MaxNumMergeCand is more than 1 (YES in S1306), then the parameter decoder 302 decodes the merge_idx (S1307).

In a case that sps_mmvd_enabled_flag==0 (NO in S1303) or MaxNumMergeCand is less than or equal to 1 (NO in S1306), in other words, merge_idx does not appear, the inter prediction parameter derivation unit 303 sets (infers) merge_idx equal to 0.

The inter prediction parameter derivation unit 303 activates the MMVD prediction processing unit 30373 in the MMVD mode, and activates the merge prediction parameter derivation unit 3036 in the merge mode.

In a case that regular_merge_flag==0, in other words, the target block is not in the regular merge mode (No in S1302), the parameter decoder 302 decodes the CIIP flag (ciip_flag) (S1310). In a case that ciip_flag==1 (YES in S1311), the CIIP parameters are decoded from the coded data (S1312). In decoding of the CIIP parameters, merge_idx may be decoded. The inter prediction parameter derivation unit 303 outputs the parameters to the inter prediction image generation unit 309.

In a case that ciip_flag==0 (NO in S1311), the inter prediction parameter derivation unit 303 determines that the target block is in the triangle mode, and the parameter decoder 302 decodes the triangle parameter (S1313). For example, as the triangle parameter, merge_triangle_split_dir, indicating a method of splitting CU into two, merge_triangle_idx0, indicating merge_idx of one of two blocks into which the CU is split, and merge_triangle_idx1, indicating merge_idx of the other block. In the case of the triangle mode, the inter prediction parameter derivation unit 303 activates the triangle prediction processing unit 30377.

In Embodiment 1, the regular merge flag may be utilized to allocate the multiple prediction modes on the tree in a well-balanced manner. This has the effect of preventing an increase in bit costs to increase coding efficiency and preventing the tree from being deep to allow processing delay to be reduced.

### Embodiment 2

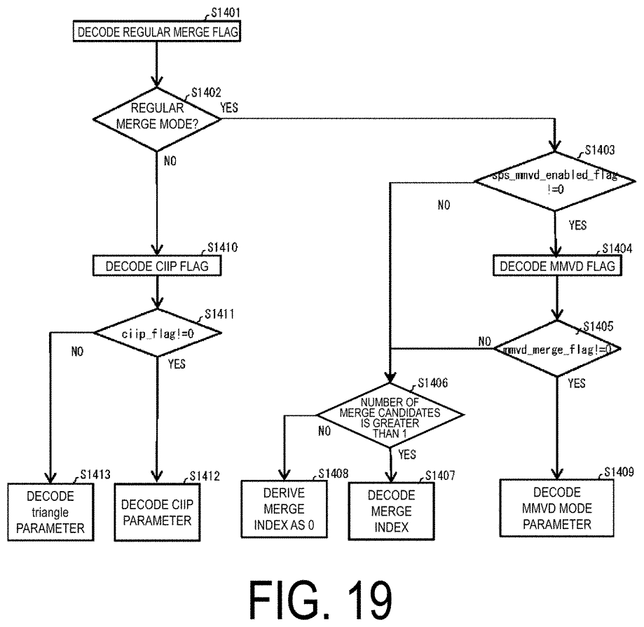

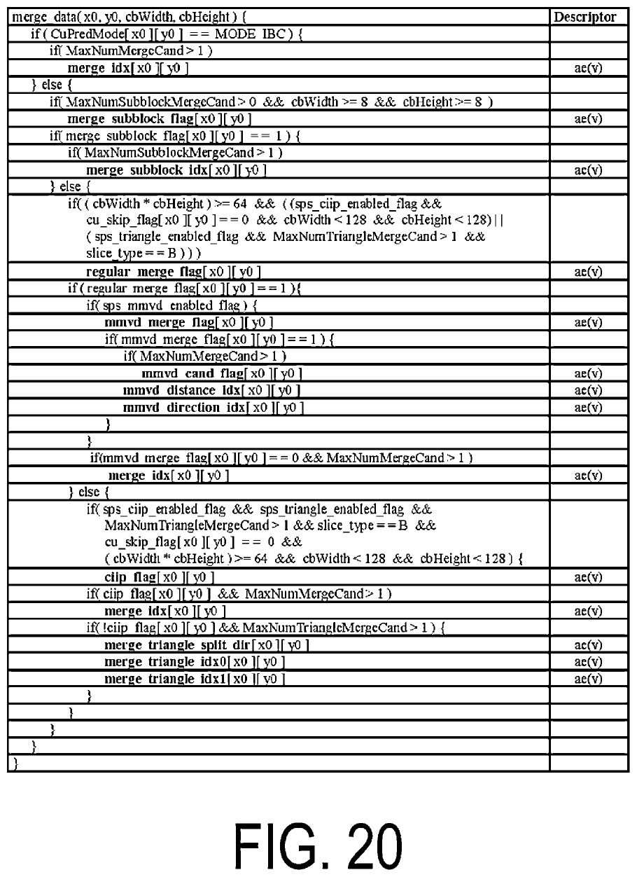

Now, a flow of prediction mode derivation processing in the parameter decoder 302 and the inter prediction parameter derivation unit 303 according to another embodiment of the present invention will be described with reference to FIG. 19 and FIG. 20. FIG. 19 is a flowchart illustrating a flow of the prediction mode derivation processing in the inter prediction parameter derivation unit 303. FIG. 20 is a diagram illustrating the syntax of the prediction mode according to the present embodiment. FIG. 19 illustrates processing corresponding to a portion of the syntax of FIG. 20.

In the flowchart of FIG. 19 and the syntax in FIG. 20, merge_idx is decoded even in a case that the MMVD prediction is not enabled by sps_mmvd_enabled_flag (sps_mmvd_enabled_flag=0), and prediction in the merge mode is performed in a case that merge_idx=1.

FIG. 19 and FIG. 18 differ from each other in the operation in the regular merge mode (S1403 to S1409), and thus the operation in the regular merge mode will be described below. The operation in other than the regular merge mode is the same as that in Embodiment 1.

The inter prediction parameter derivation unit 303 checks the value of sps_mmvd_enabled_flag (S1403). In a case that the sps_mmvd_enabled_flag==1, in other words, the MMVD prediction is available (YES in S1403), the parameter decoder 302 decodes the MMVD flag (mmvd_merge_flag) from the coded data (S1404).

In a case that the mmvd_merge_flag==1, in other words, the MMVD flag indicates the MMVD mode (YES in S1405), the parameter decoder 302 decodes the parameters for the MMVD mode from the coded data (S1409).

In a case that mmvd_merge_flag==0 (NO in S1403) or sps_mmvd_enabled_flag==0 (NO in S1405) (MMVD flag does not indicate the MMVD mode) and that the number of merge candidates MaxNumMergeCand is greater than 1 (YES in S1406), the parameter decoder 302 decodes the merge_idx (S1407).

In a case that MaxNumMergeCand is less than or equal to 1 (NO in S1406), in other words, merge_idx does not appear, the inter prediction parameter derivation unit 303 sets (infers) merge_idx equal to 0.

The inter prediction parameter derivation unit 303 activates the MMVD prediction processing unit 30373 in the MMVD mode, and activates the merge prediction parameter derivation unit 3036 in the merge mode.

In Embodiment 2, the regular merge flag is utilized to categorize into 1) the group of the merge mode and the MMVD mode, and 2) the group of the intra-inter mode (CIIP mode) and the triangle mode. And in the branch to 1), sps_mmvd_enabled_flag decoded from the parameter set and mmvd_merge_flag for decoding in CU units are used to select whether the target CU uses the MMVD prediction or the merge mode does not use MMVD. Furthermore, in addition to a case that mmvd_merge_flag is 0, even in a case that sps_mmvd_enabled_flag==0, the merge index is decoded in a case that the number of merge candidates is greater than 1. Thus, even in a case that the MMVD mode is inhibited by a higher syntax, the merge mode can be selectively used, thus producing the effect of achieving high coding efficiency.

In a case that the affine_flag indicates 1, that is, the affine prediction mode, the affine prediction processing unit 30372 derives the inter prediction parameters in sub-block units.

In a case that the mmvd_flag indicates 1, that is, the MMVD prediction mode, the MMVD prediction processing unit 30373 derives an inter prediction parameter from the merge candidate and the difference vector derived by the merge prediction parameter derivation unit 3036.

In a case that TriangleFlag indicates 1, that is, the Triangle prediction mode, the Triangle prediction processing unit 30377 derives a Triangle prediction parameter.

In a case that merge_flag indicates 1, that is, the merge prediction mode, merge_idx is derived and output to the merge prediction parameter derivation unit 3036.

In a case that the merge_flag indicates 0, that is, the AMVP prediction mode, the AMVP prediction parameter derivation unit 3032 derives mvpLX from inter_pred_idc, refIdxLX, or mVP_Lx_idx.

### MV Addition Unit

In the MV addition unit 3038, mvpLX and mvdLX derived are added together to derive mvLX.

### Affine Prediction Processing Unit

The affine prediction processing unit 30372 derives 1) motion vectors for two control points CP0, CP1 or three control points CP0, CP1, CP2 of the target block, 2) derive affine prediction parameters for the target block, and 3) derives a motion vector for each sub-block from the affine prediction parameter.

In the case of merge affine prediction, a motion vector cpMvLX[ ] for each control point CP0, CP1, CP2 is derived from a motion vector for an adjacent block of the target block. In the case of inter affine prediction, cpMvLX[ ] for each control point is derived from the sum of the prediction vector for each control point CP0, CP1, CP2 and the difference vector mvdCpLX[ ] derived from the coded data.

The motion vector spMvLX for each sub-block constituting the target block (bW*bH) is derived as a motion vector for each point (xPosCb, yPosCb) located at the center of each sub-block.

The affine prediction processing unit 30372 derives an affine prediction parameter (mvScaleHor, mvScalerVer, dHorX, dHorY, dHorX, dVerY) for the target block from the motion vector for the control point.

Based on the affine prediction parameter for the target block, the affine prediction processing unit 30372 derives spMvLX[i][j] in the target block (i=0, 1, 2, . . . , (bW/sbW)−1, j=0, 1, 2, . . . , (bH/sbH)−1).

Furthermore, the coordinates (xSb, ySb) of the upper left block of the sub-block are used to assign spMvLX[i][j] to mvLX in the corresponding picture.

### Merge Prediction

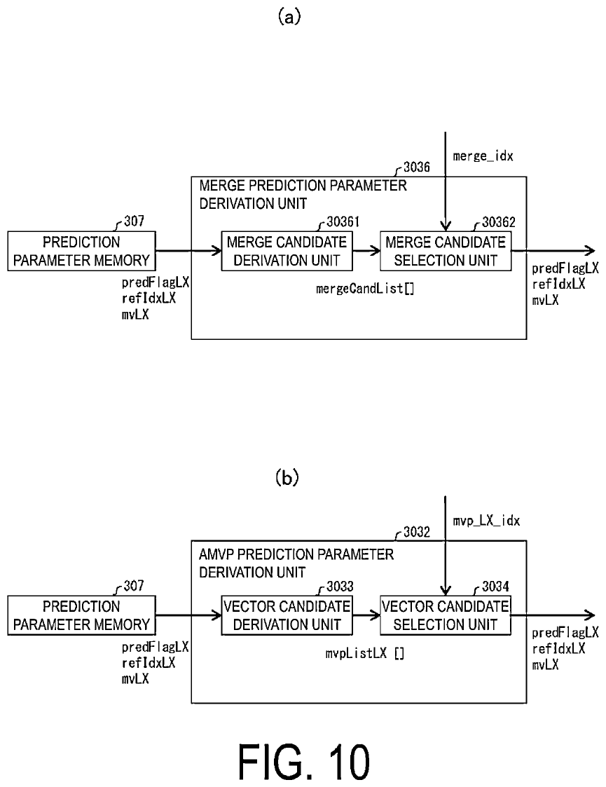

FIG. 10(a) is a schematic diagram illustrating the configuration of the merge prediction parameter derivation unit 3036 according to the present embodiment. The merge prediction parameter derivation unit 3036 includes a merge candidate derivation unit 30361 and a merge candidate selection unit 30362. Note that a merge candidate includes the prediction parameter (predFlagLX, mvLX, and refIdxLX) and is stored in the merge candidate list. The merge candidate stored in the merge candidate list is assigned an index in accordance with a prescribed rule.

The merge candidate derivation unit 30361 derives the merge candidate using the motion vector and refIdxLX for the decoded adjacent block without any change. In addition, the merge candidate derivation unit 30361 may apply spatial merge candidate derivation processing, temporal merge candidate derivation processing, pairwise merge candidate derivation processing, and zero merge candidate derivation processing described below.

As the spatial merge candidate derivation processing, the merge candidate derivation unit 30361 reads the prediction parameter stored in the prediction parameter memory 307 in accordance with a prescribed rule, and configures the prediction parameter as a merge candidate. A reference picture specification method is, for example, a prediction parameter related to each of the adjacent blocks located within a prescribed range from the target block (e.g., all or some of a block A1 on the left of and share the boarder with the target block, a block B1 on the right of and share the boarder with the target block, a block B0 at the upper right of and tangent to the target block, a block A0 at the lower left of and tangent to the target block, and a block B2 at the upper left of and tangent to the target block). The merge candidates are referred to as A1, B1, B0, A0, and B2. In this regard, A1, B1, B0, A0, and B2 are motion information derived from blocks including the following coordinates. FIG. 14(b) illustrates the positions of A1, B1, B0, A0, and B2.

A1:(xCb−1,yCb+cbHeight−1)

B1:(xCb+cbWidth−1,yCb−1)

B0:(xCb+cbWidth,yCb−1)

A0:(xCb−1,yCb+cbHeight)

B2:(xCb−1,yCb−1)

The target block has upper left coordinates (xCb, yCb), a width cbWidth, and a height cbHeight.

As temporal merge derivation processing, the merge candidate derivation unit 30361 reads, from the prediction parameter memory 307, the prediction parameter for a block C in the reference image including the lower right coordinates CBR or the center coordinates of the target block, specifies the block C as a merge candidate Col, and stores the block C in the merge candidate list mergeCandList[ ].

The pairwise candidate derivation unit derives a pairwise candidate avgK from the average of the two merge candidates (p0Cand and p1Cand) stored in mergeCandList and stores the pairwise candidate avgK in mergeCandList[ ].

MvLXavgK[0]=(mvLXp0Cand[0]+mvLXp1Cand[0])/2

MvLXavgK[1]=(mvLXp0Cand[1]+mvLXp1Cand[1])/2

The merge candidate derivation unit 30361 derives zero merge candidates Z0, . . . , ZM in which refIdxLX is 0 M and in which an X component and a Y component of mvLX are both 0, and store the zero merge candidates in the merge candidate list.

The storage in mergeCandList[ ] is in the order of, for example, spatial merge candidates (A1, B1, B0, A0, and B2), the temporal merge candidate Col, the pairwise merge candidate avgK, and the zero merge candidate ZK. Note that a reference block that is not available (intra prediction block, or the like) is not stored in the merge candidate list.

i=0
if (availableFlagA1)
mergeCandList[i++]=A1
if (availableFlagB1)
mergeCandList[i++]=B1
if (availableFlagB0)
mergeCandList[i++]=B0
if (availableFlagA0)
mergeCandList[i++]=A0
if (availableFlagB2)
mergeCandList[i++]=B2
if (availableFlagCol)
mergeCandList[i++]=Col
if (availableFlagAvgK)
mergeCandList[i++]=avgK
if (i<MaxNumMergeCand)
mergeCandList[i++]=ZK

The merge candidate selection unit 30362 selects a merge candidate N indicated by merge_idx from the merge candidates included in the merge candidate list, in accordance with the equation below.

N=mergeCandList[merge_idx]

Here, N is a label indicating a merge candidate, and takes A1, B1, B0, A0, B2, Col, avgK, ZK, and the like. The motion information of the merge candidate indicated by the label N is indicated by (mvLXN[0], mvLXN[0]), predFlagLXN, and refIdxLXN.

(mvLXN[0], mvLXN[0]), predFlagLXN, and refIdxLXN selected are selected as inter prediction parameters for the target block. The merge candidate selection unit 30362 stores the inter prediction parameter for the selected merge candidate in the prediction parameter memory 307 and outputs the inter prediction parameter to the inter prediction image generation unit 309.

### MMVD Prediction Processing Unit 30373

The MMVD prediction processing unit 30373 determines mvLX by adding mvdLX at a prescribed distance and in a prescribed direction to the center vector mvpLX (motion vector mvLXN of the merge candidate N) derived by the merge candidate derivation unit 30361. The MMVD prediction processing unit 30373 derives a center vector mvLX[ ] using a syntax element mmvd_cand_flag (FIG. 14 (a)) of coded data, and derives a difference vector mvpLX[ ] from mmvd_direction_idx (FIG. 14(d)) indicating an index for a direction table and mmvd_distance_idx (FIG. 14(d)) indicating an index for a distance table.

The MMVD prediction processing unit 30373 selects the center vector mvLXN[ ] by using mmvd_cand_flag.

N=mergeCandList[mmvd_cand_flag]

The MMVD prediction processing unit 30373 derives a direction (MmvdSign[0], MmvdSign[1]) from mmvd_direction_idx, and derives a distance MmvdDistance from mmvd_distance_idx. Note that a table DistanceTable used to derive MmvdDistance is switched by a flag slice_fpel_mmvd_enabled_flag indicating whether to configure the precision of the motion vector as an integral precision at a slice level. Specifically, in a case that slice_fpel_mmvd_enabled_flag is 0,

DistanceTable[ ]={1,2,4,8,16,32,64,128}, and

in a case that slice_fpel_mmvd_enabled_flag is 1,

DistanceTable[ ]={4,8,16,32,64,128,256,512}.

dir_table_x[ ]={1,−1,0,0}

dir_table_y[ ]={0,0,1,−1}

MmvdSign[0]=dir_table_x[mmvd_direction_idx]

MmvdSign[1]=dir_table_y[mmvd_direction_idx]

MmvdDistance=DistanceTable[mmvd_distance_idx]

The MMVD prediction processing unit 30373 derives a difference vector refineMv[ ] using the product of (MmvdSign[0], MmvdSign[1]) and MmvdDistance.

firstMv[0]=(MmvdDistance<<shiftMMVD)*MmvdSign[0]

firstMv[1]=(MmvdDistance<<shiftMMVD)*MmvdSign[1]

Here, shiftMMVD is a value adjusting the magnitude of the difference vector such that the magnitude is suitable for the precision MVPREC of the motion vector in the motion compensation unit 3091 (interpolation unit).

refineMvL0[0]=firstMv[0]

refineMvL0[1]=firstMv[1]

refineMvL1[0]=−firstMv[0]

refineMvL1[1]=−firstMv[1]

Finally, the MMVD prediction processing unit 30373 derives a motion vector for the MMVD merge candidate from refineMvLX and the center vector mvLXN as follows.

mvL0[0]=mvL0N[0]+refineMvL0[0]

mvL0[1]=mvL0N[1]+refineMvL0[1]

mvL1[0]=mvL1N[0]+refineMvL1[0]

mvL1[1]=mvL1N[1]+refineMvL1[1]

### Triangle Prediction

The Triangle prediction will now be described. In Triangle prediction, the target CU is split into two triangular prediction units by using a diagonal line or an opposite diagonal line as a boundary. The prediction image in each triangle prediction unit is derived by performing weighting mask processing on each pixel of the prediction image of the target CU (the rectangular block including the triangular prediction unit) depending on the position of the pixel. Intuitively, a triangular image can be derived from a rectangular image by multiplication by a mask in which an upper right pixel is 1, whereas a lower right pixel is 0. The adaptive weighting processing of the prediction image is applied to both regions across the diagonal line, and one prediction image of the target CU (rectangular block) is derived by adaptive weighting processing using two prediction images. This processing is referred to as Triangle combining processing. Transform (inverse transform) and quantization (inverse quantization) processing is applied to the entire target CU. Note that the Triangle prediction is applied only in a case of the merge prediction mode or the skip mode.

In the triangle mode, the Triangle prediction processing unit 30377 derives the prediction parameters corresponding to the two triangular regions used for the Triangle prediction, and supplies the predicted prediction parameters to the inter prediction image generation unit 309. The Triangle prediction may be configured not to use bi-prediction for simplification of processing. In this case, an inter prediction parameter for a uni-prediction is derived in one triangular region. Note that the motion compensation unit 3091 and the Triangle combining unit 30952 derive two prediction images and perform composition by using the prediction images.

### DMVR

Now, a DECODER side Motion Vector Refinement (DMVR) processing performed by the DMVR unit 30375 will be described. In a case that the merge_flag is 1 or the skip flag skip_flag is 1 for the target CU, the DMVR unit 30375 refines mvLX of the target CU derived by the merge prediction processing unit 30374 by using the reference image. Specifically, in a case that the prediction parameter derived by the merge prediction processing unit 30374 indicates bi-prediction, the motion vector is refined by using the prediction image derived from the motion vector corresponding to two reference pictures. mvLX refined is supplied to the inter prediction image generation unit 309.

### AMVP Prediction

FIG. 10(b) is a schematic diagram illustrating the configuration of the AMVP prediction parameter derivation unit 3032 according to the present embodiment. The AMVP prediction parameter derivation unit 3032 includes a vector candidate derivation unit 3033 and a vector candidate selection unit 3034. The vector candidate derivation unit 3033 derives a prediction vector candidate from the motion vector for the decoded adjacent block stored in the prediction parameter memory 307 based on refIdxLX, and stores the result in a prediction vector candidate list mvpListLX[ ].

The vector candidate selection unit 3034 selects a motion vector mvpListLX[mvp_LX_idx] indicated by mvp_LX_idx, among the prediction vector candidates of the prediction vector candidate list mvpListLX[ ], as mvpLX. The vector candidate selection unit 3034 outputs mvpLX selected to the addition unit 3038.

### MV Addition Unit

The addition unit 3038 adds mvpLX input from the AMVP prediction parameter derivation unit 3032 and mvdLX decoded, to calculate mvLX. The addition unit 3038 outputs mvLX calculated to the inter prediction image generation unit 309 and the prediction parameter memory 307.

mvLX[0]=mvpLX[0]+mvdLX[0]

mvLX[1]=mvpLX[1]+mvdLX[1]

### Precision of Motion Vector

amvr_mode is a syntax element that switches the precision of the motion vector derived in the AMVP mode, and, for example, switches between ¼ pixel precision and 1 pixel precision and 4 pixel precision in a case that amvr_mode=0, 1, 2. Instead of amvr_mode, a flag amvr_flag indicating whether the precision is ¼ and a flag amvr_precision_flag switching between 1/16 and 1 may be used.

In a case that the precision of motion vectors is 1/16, inverse quantization may be performed by using MvShift (=1<<amvr_mode=(amvr_flag+amvr_precision_flag)<<1) derived from the amvr_mode as described below, in order to change the motion vector difference with a ¼, 1, or 4 pixel precision to a motion vector difference with a 1/16 pixel precision.

MvdLX[0]=MvdLX[0]<<(MvShift+2)

MvdLX[1]=MvdLX[1]<<(MvShift+2)

Similarly, in a case that the affine_flag is 1, the equation below is used for the derivation.

MvShift=amvr_precision_flag?(amvr_precision_flag<<1):(−(amvr_flag<<1))

MvdCpLX[cpIdx][0]=MvdLX[cpIdx][0]<<(MvShift+2)

MvdCpLX[cpIdx][1]=MvdLX[cpIdx][1]<<(MvShift+2)

Note that furthermore, the parameter decoder 302 may decode and derive mvdLX[ ] not subjected yet to shifting by MvShift described above, by decoding the syntax elements below.

abs_mvd_greater0_flag

abs_mvd_minus2

mvd_sign_flag

Then, the parameter decoder 302 decodes a difference vector 1Mvd[ ] from the syntax elements by using the equation below.

1Mvd[compIdx]=abs_mvd_greater0_flag[compIdx]*(abs_mvd_minus2[compIdx]+2)*(1−2*mvd_sign_flag[compIdx]

Furthermore, 1Mvd[ ] is configured as MvdLX for a translation MVD (MotionModelIdc[x][y]==0) and configured as MvdCpLX for a control point MVD (MotionModelIdc[x][y]!=0).

if (MotionModelIdc==0)

MvdLX[compIdx]=1Mvd[compIdx]

else

MvdCpLX[cpIdx][compIdx]=1Mvd[cpIdx][compIdx]

Here, compIdx=0 or 1, cpIdx=0, 1, or 2.

### Motion Vector Scaling

A derivation method for the scaling of a motion vector will be described. Assuming that a motion vector is Mv (reference motion vector), a picture including a block with an Mv is PicMv, a reference picture for the Mv is PicMvRef, a motion vector subjected to scaling is sMv, a picture including a block with an sMv is CurPic, a reference picture referenced by sMv is CurPicRef, a derivation function MvScale (Mv, PicMv, PicMvRef, CurPic, CurPicRef) for the sMv is represented by the following equation.

sMv=MvScale(Mv,PicMv,PicMvRef,CurPic,CurPicRef)=Clip3(−R1,R1−1,sign(distScaleFactor*Mv)*((abs(distScaleFactor*Mv)+round1−1)>>shift1))

distScaleFactor=Clip3(−R2,R2−1,(tb*tx+round2)>>shift2)

tx=(16384+abs(td)>>1)/td

td=DiffPicOrderCnt(PicMv,PicMvRef)

tb=DiffPicOrderCnt(CurPic,CurPicRef)

Here, the round1, round2, shift1, and shift2 are round values and shift values for division using reciprocal, such as, for example, round1=1<<(shift1−1), round2=1<<(shift2−1), shift1=8, shift2=6, etc. DiffPicOrderCnt (Pic1, Pic2) is a function that returns the difference in time information (e.g., POC) between Pic1 and Pic2. For example, R1 and R2 are used to limit the range of values for performing the processing with limited precision, and, for example, R1=32768, R2=4096, and the like.

Additionally, the scaling function MvScale (Mv, PicMv, PicMvRef, CurPic, CurPicRef) may be expressed by the equation below.

MvScale(Mv,PicMv,PicMvRef,CurPic,CurPicRef)=MV*DiffPicOrderCnt(CurPic,CurPicRef)/DiffPicOrderCnt(PicMv,PicMvRef)

That is, the Mv may be scaled according to the ratio between the difference in time information between CurPic and CurPicRef and the difference in time information between PicMv and PicMvRef.

### Configuration of Intra Prediction Parameter Derivation Unit 304

The intra prediction parameter derivation unit 304 decodes an intra prediction parameter, for example, an intra prediction mode IntraPredMode, with reference to the prediction parameters stored in the prediction parameter memory 307, based on input from the parameter decoder 302. The intra prediction parameter derivation unit 304 outputs the decoded intra prediction parameter to the prediction image generation unit 308, and stores the decoded intra prediction parameter in the prediction parameter memory 307. The intra prediction parameter derivation unit 304 may derive different intra prediction modes between luma and chroma.

The loop filter 305 is a filter provided in the coding loop, and is a filter that removes block distortion and ringing distortion and improves image quality. The loop filter 305 applies a filter such as a deblocking filter, a Sample Adaptive Offset (SAO), and an Adaptive Loop Filter (ALF) on a decoded image of a CU generated by the addition unit 312.

The reference picture memory 306 stores a decoded image of the CU in a predefined position for each target picture and target CU.

The prediction parameter memory 307 stores the prediction parameter in a predefined position for each CTU or CU. Specifically, the prediction parameter memory 307 stores the parameter decoded by the parameter decoder 302, the parameter derived by the prediction parameter derivation unit 320, and the like.

Parameters derived by the prediction parameter derivation unit 320 are input to the prediction image generation unit 308. In addition, the prediction image generation unit 308 reads a reference picture from the reference picture memory 306. The prediction image generation unit 308 generates a prediction image of a block or a subblock by using the parameters and the reference picture (reference picture block) in the prediction mode indicated by predMode. Here, the reference picture block refers to a set of pixels (referred to as a block because they are normally rectangular) on a reference picture and is a region that is referenced for generating a prediction image.

### Inter Prediction Image Generation Unit 309

In a case that predMode indicates the inter prediction mode, the inter prediction image generation unit 309 generates a prediction image of a block or a subblock by inter prediction by using the inter prediction parameters input from the inter prediction parameter derivation unit 303 and the read reference picture.

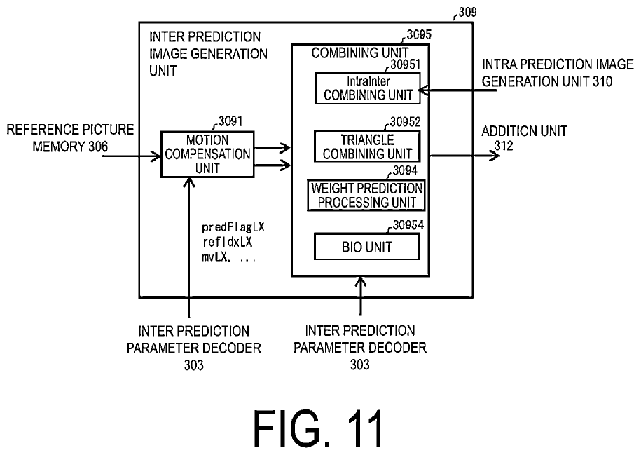

FIG. 11 is a schematic diagram illustrating the configuration of the inter prediction image generation unit 309 included in the prediction image generation unit 308 according to the present embodiment. The inter prediction image generation unit 309 includes a motion compensation unit (prediction image generation unit) 3091 and a combining unit 3095. The combining unit 3095 includes an IntraInter combining unit 30951 that generates a prediction image for intra inter prediction (CIIP mode), a Triangle combining unit 30952, a BIO unit 30954, and a weight prediction processing unit 3094.

### Motion Compensation

The motion compensation unit 3091 (interpolation image generation unit 3091) generates an interpolation image (motion compensation image) by reading a reference block from the reference picture memory 306 based on the inter prediction parameters (predFlagLX, refIdxLX, mvLX) input from the inter prediction parameter derivation unit 303. The reference block is a block located on the reference picture RefPicLX designated by refIdxLX, at a position shifted by mvLX from the position of the target block. Here, in a case that mvLX does not have an integer precision, an interpolation image is generated by using a filter referred to as a motion compensation filter and configured to generate pixels at fractional positions.

The motion compensation unit 3091 first derives an integer position (xInt, yInt) and a phase (xFrac, yFrac) corresponding to in-prediction block coordinates (x, y) by the following equation.

xInt=xPb+(mvLX[0]>>(log 2(MVPREC)))+x

xFrac=mvLX[0]&(MVPREC−1)

yInt=yPb+(mvLX[1]>>(log 2(MVPREC)))+y

YFrac=mvLX[1]&(MVPREC−1)

Here, (xPb, yPb) indicates the upper left coordinates of a block with a bW*bH size, that is, x=0 bW−1, y=0 bH−1, and MVPREC indicates the precision of the motion vector mvLX (1/MVPREC pixel precision). For example, MVPREC=16.

The motion compensation unit 3091 derives a temporary image temp[ ][ ] by performing horizontal interpolation processing on a reference picture refImg using an interpolation filter. In the equation below, Σ is the sum related to k of k=0, . . . , NTAP−1, shift1 is a normalization parameter for adjusting a value range, and offset1=1<<(shift1−1).

temp[x][y]=(ΣmcFilter[xFrac][k]*refImg[xInt+k−NTAP/2+1][yInt]+offset1)>>shift1

Subsequently, the motion compensation unit 3091 derives an interpolation image Pred[ ][ ] by performing vertical interpolation processing on the temporary image temp[ ][ ]. In the equation below, Σ is the sum related to k of k=0, . . . , NTAP−1, shift2 is a normalization parameter for adjusting the value range, and offset2=1<<(shift2−1).

Pred[x][y]=(ΣmcFilter[yFrac][k]*temp[x][y+k−NTAP/2+1]+offset2)>>shift2 Note that for bi-prediction, Pred[ ] described above is derived for each of the L0 list and the L1 list (referred to as interpolation images PredL0[ ][ ] and PredL1[ ][ ]), and an interpolation image Pred[ ][ ] is generated from PredL0[ ][ ] and PredL1[ ][ ].

The combining unit 3095 includes the IntraInter combining unit 30951, the Triangle combining unit 30952, the weight prediction processing unit 3094, and the BIO unit 30954.

### IntraInter Combining Processing

In a case that ciip_flag is 1, the intra prediction image generation unit 310 configures a planar prediction (IntraPredModeY=INTRA_PLANAR) and generates a prediction image predSamplesIntra[ ][ ].

In a case that ciip_flag is 1, the inter prediction image generation unit 309 generates a prediction image predSamplesInter[ ][ ] by performing motion compensation using the motion vector obtained by the merge prediction.

In a case that ciip_flag is 1, IntraInter combining unit 30951 generates a prediction image predSamplesComb[ ][ ] by using the weighted sum of an inter prediction image predSamplesInter[ ] and an intra prediction image predSamplesIntra[ ][ ], and outputs the prediction image predSamplesComb to the addition unit 312.

predSamplesComb[x][y]=(w*predSamplesIntra[x][y]+(4−w)*predSamplesInter[x][y]+2)>>2

Here, w is set equal to 3 in a case that both the upper and left adjacent blocks of the target CU are in intra mode, and as 1 in a case that both are other than the intra mode, and is otherwise set equal to 2.

### Triangle Combining Processing

The Triangle combining unit 30952 generates a prediction image using the Triangle prediction described above.

### BIO Prediction

Now, the details of a BIO prediction (Bi-Directional Optical Flow, BDOF processing) performed by the BIO unit 30954 will be described. In a bi-prediction mode, the BIO unit 30954 generates a prediction image with reference to two prediction images (first prediction image and second prediction image) and a gradient correction term.

In a case that the inter prediction parameter decoder 303 determines an L0 unidirectional prediction, the motion compensation unit 3091 generates PredL0[x][y]. In a case that the inter prediction parameter decoder 303 determines an L1 unidirectional prediction, the motion compensation unit 3091 generates PredL1[x][y]. On the other hand, in a case that the inter prediction parameter decoder 303 determines the bi-prediction mode, the combining unit 3095 references bioAvailableFlag indicating whether to perform BIO processing to determine whether the BIO processing is necessary. In a case that bioAvailableFlag indicates TRUE, the BIO unit 30954 performs the BIO processing to generate a bi-directional prediction image, and in a case that bioAvailableFlag indicates FALSE, the combining unit 3095 generates a prediction image by normal bi-directional prediction image generation.

The inter prediction parameter decoder 303 may derive TRUE for bioAvailableFlag in a case that an L0 reference image refImgL0 and an L1 reference image refImgL1 differ from each other and that the two pictures are in opposite directions with respect to the target picture.

### Weighted Prediction

The weight prediction processing unit 3094 generates a prediction image of a block by multiplying an interpolation image PredLX by a weight coefficient. In a case that one of prediction list utilization flags (predFlagL0 or predFlagL1) is 1 (uni-prediction) and that no weighted prediction is used, processing in accordance with the equation below is executed in which PredLX (LX is L0 or L1) is adapted to the number of pixel bits bitDepth.

Pred[x][y]=Clip3(0,(1<<bitDepth)−1,(PredLX[x][y]+offset1)>>shift1)

Here, shift1=14−bitDepth, offset1=1<<(shift1−1) are established.

In a case that both of prediction list utilization flags (predFlagL0 and predFlagL1) are 1 (bi-prediction PRED_BI) and that no weight prediction is used, processing in accordance with the equation below is executed in which PredL0 and PredL1 are averaged and adapted to the number of pixel bits.

Pred[x][y]=Clip3(0,(1<<bitDepth)−1,(PredL0[x][y]+PredL1[x][y]+offset2)>>shift2)

Here, shift2=15−bitDepth, offset2=1<<(shift2−1) are established.

Furthermore, in a case that the uni-prediction and the weighted prediction are performed, the weight prediction processing unit 3094 derives a weighted prediction coefficient w0 and an offset o0 from coded data, and performs processing by the following equation.

Pred[x][y]=Clip3(0,(1<<bitDepth)−1,((PredLX[x][y]*w0+2\hat{ }(log 2WD−1))>>log 2WD)+o0)

Here, log 2WD is a variable indicating a prescribed shift amount.

Furthermore, in a case that the bi-prediction PRED_BI and the weight prediction are performed, the weight prediction processing unit 3094 derives weight coefficients w0, w1, o0, and of from the coded data, and performs processing in accordance with the equation below.

Pred[x][y]=Clip3(0,(1<<bitDepth)−1,(PredL0[x][y]*w0+PredL1[x][y]*w1+((o0+o1+1)<<log 2WD))>>(log 2WD+1))

The inter prediction image generation unit 309 outputs the generated prediction image of the block to the addition unit 312.

### Intra Prediction Image Generation Unit 310

In a case that predMode indicates an intra prediction mode, the intra prediction image generation unit 310 performs an intra prediction by using an intra prediction parameter input from the intra prediction parameter derivation unit 304 and a reference picture read out from the reference picture memory 306.

Specifically, the intra prediction image generation unit 310 reads, from the reference picture memory 306, adjacent blocks located on the target picture within a prescribed range from the target block. The prescribed range corresponds to a left, an upper left, an upper, and an upper right adjacent blocks of the target block, and the referenced area varies depending on the intra prediction mode.

The intra prediction image generation unit 310 references decoded pixel values read out and the prediction mode indicated by IntraPredMode to generate a prediction image of the target block. The intra prediction image generation unit 310 outputs the generated prediction image of the block to the addition unit 312.

The generation of the prediction image based on the intra prediction mode will be described below. In the Planar prediction, DC prediction, and Angular prediction, decoded peripheral regions adjacent to (proximate to) the prediction target block are configured as a reference region R. Then, the pixels on the reference region R are extrapolated in a particular direction to generate the prediction image. For example, the reference region R may be configured as an L-shaped region including a left and an upper regions (or further an upper left, an upper right, and a lower left regions) of the prediction target block.

The Planar prediction generates a temporary prediction image by linearly adding reference samples s[x][y] together in accordance with the distance between a prediction target pixel position and a reference pixel position.

The inverse quantization and inverse transform processing unit 311 performs inverse quantization on a quantization transform coefficient input from the parameter decoder 302 to calculate a transform coefficient.

The addition unit 312 adds the prediction image of the block input from the prediction image generation unit 308 and the prediction error input from the inverse quantization and inverse transform processing unit 311 to each other for each pixel, and generates a decoded image of the block. The addition unit 312 stores the decoded image of the block in the reference picture memory 306, and also outputs it to the loop filter 305.

### Configuration of Video Coding Apparatus

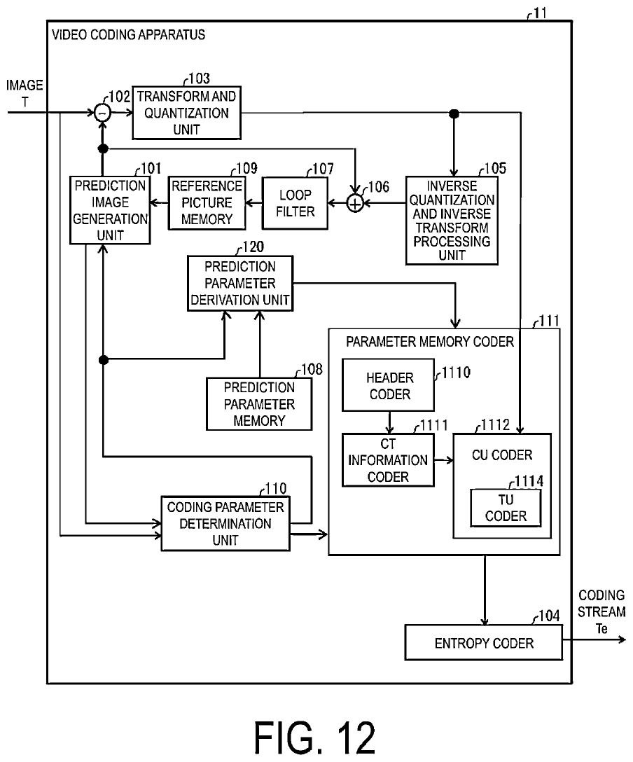

Next, a configuration of the video coding apparatus 11 according to the present embodiment will be described. FIG. 12 is a block diagram illustrating a configuration of the video coding apparatus 11 according to the present embodiment. The video coding apparatus 11 includes a prediction image generation unit 101, a subtraction unit 102, a transform and quantization unit 103, an inverse quantization and inverse transform processing unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, a parameter coder 111, a prediction parameter derivation unit 120, and an entropy coder 104.

The prediction image generation unit 101 generates a prediction image for each CU. The prediction image generation unit 101 includes the inter prediction image generation unit 309 and intra prediction image generation unit 310 already described, and description of these units is omitted.

The subtraction unit 102 subtracts a pixel value of the prediction image of a block input from the prediction image generation unit 101 from a pixel value of the image T to generate a prediction error. The subtraction unit 102 outputs the prediction error to the transform and quantization unit 103.

The transform and quantization unit 103 performs a frequency transform on the prediction error input from the subtraction unit 102 to calculate a transform coefficient, and derives a quantization transform coefficient by quantization. The transform and quantization unit 103 outputs the quantization transform coefficient to the parameter coder 111 and the inverse quantization and inverse transform processing unit 105.

The inverse quantization and inverse transform processing unit 105 is the same as the inverse quantization and inverse transform processing unit 311 (FIG. 7) in the video decoding apparatus 31, and descriptions thereof are omitted. The calculated prediction error is output to the addition unit 106.

The parameter coder 111 includes a header coder 1110, a CT information coder 1111, and a CU coder 1112 (prediction mode coder). The CU coder 1112 further includes a TU coder 1114. General operation of each module will be described below.

The header coder 1110 performs coding processing of parameters such as header information, split information, prediction information, and quantization transform coefficients.

The CT information coder 1111 codes the QT and MT (BT, TT) split information and the like.

The CU coder 1112 codes the CU information, the prediction information, the split information, and the like.

In a case that a prediction error is included in the TU, the TU coder 1114 codes the QP update information and the quantization prediction error.

The CT information coder 1111 and the CU coder 1112 supplies, to the parameter coder 111, syntax elements such as the inter prediction parameters (predMode, merge_flag, merge_idx, inter_pred_idc, refIdxLX, mvp_LX_idx, mvdLX), the intra prediction parameters (intra_luma_mpm_flag, intra_luma_mpm_idx, intra_luma_mpm_reminder, intra_chroma_pred_mode), and the quantization transform coefficient.

The parameter coder 111 inputs the quantization transform coefficient and the coding parameters (split information and prediction parameters) to the entropy coder 104. The entropy coder 104 entropy-codes the quantization transform coefficient and the coding parameters to generate a coding stream Te and outputs the coding stream Te.

The prediction parameter derivation unit 120 is a component including the inter prediction parameter coder 112 and the intra prediction parameter coder 113, and derives an intra prediction parameter and an intra prediction parameter from the parameters input from the coding parameter determination unit 110. The intra prediction parameter and intra prediction parameter derived are output to the parameter coder 111.

### Configuration of Inter Prediction Parameter Coder

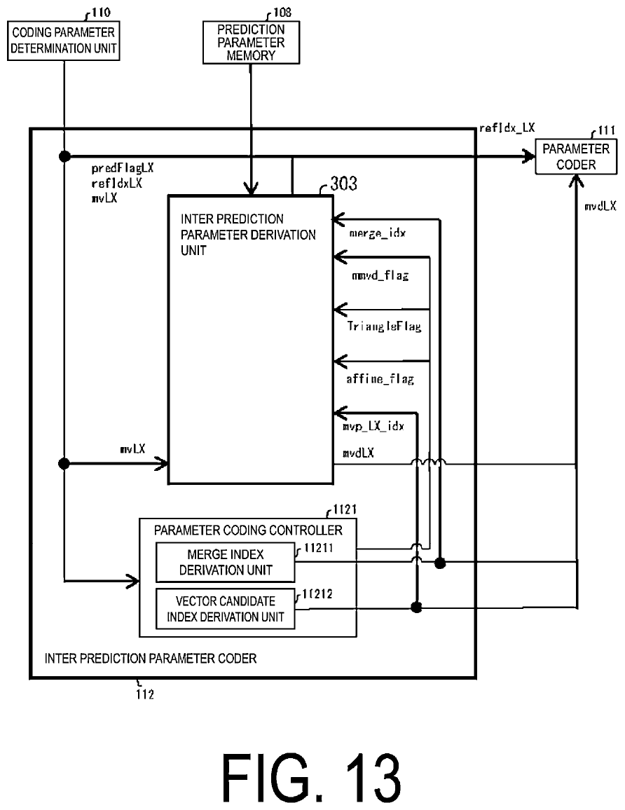

The inter prediction parameter coder 112 includes a parameter coding control unit 1121 and an inter prediction parameter derivation unit 303 as described in FIG. 13. The inter prediction parameter derivation unit 303 has a configuration common to the video decoding apparatus. The parameter coding controller 1121 includes a merge index derivation unit 11211 and a vector candidate index derivation unit 11212.

The merge index derivation unit 11211 derives merge candidates and the like, and outputs the merge candidates and the like to the inter prediction parameter derivation unit 303. The vector candidate index derivation unit 11212 derives prediction vector candidates and the like, and outputs the prediction vector candidates and the like to the inter prediction parameter derivation unit 303 and the parameter coder 111.

### Configuration of Intra Prediction Parameter Coder 113

The intra prediction parameter coder 113 includes a parameter coding control unit 1131 and the intra prediction parameter derivation unit 304. The intra prediction parameter derivation unit 304 has a configuration common to the video decoding apparatus.

The parameter coding control unit 1131 derives IntraPredModeY and IntraPredModeC. Furthermore, with reference to mpmCandList[ ], intra_luma_mpm_flag is determined. These prediction parameters are output to the intra prediction parameter derivation unit 304 and the parameter coder 111.

However, unlike in the video decoding apparatus, the coding parameter determination unit 110 and the prediction parameter memory 108 provide input to the inter prediction parameter derivation unit 303 and the intra prediction parameter derivation unit 304, and output from the inter prediction parameter derivation unit 303 and the intra prediction parameter derivation unit 304 is provided to the parameter coder 111.

The addition unit 106 adds together, for each pixel, a pixel value for the prediction block input from the prediction image generation unit 101 and a prediction error input from the inverse quantization and inverse transform processing unit 105, generating a decoded image. The addition unit 106 stores the generated decoded image in the reference picture memory 109.

The loop filter 107 applies a deblocking filter, an SAO, and an ALF to the decoded image generated by the addition unit 106. Note that the loop filter 107 need not necessarily include the above-described three types of filters, and may have a configuration of only the deblocking filter, for example.

The prediction parameter memory 108 stores the prediction parameters generated by the coding parameter determination unit 110 for each target picture and CU at a predetermined position.

The reference picture memory 109 stores the decoded image generated by the loop filter 107 for each target picture and CU at a predetermined position.

The coding parameter determination unit 110 selects one set among multiple sets of coding parameters. The coding parameters include QT, BT, or TT split information described above, a prediction parameter, or a parameter to be coded which is generated related thereto. The prediction image generation unit 101 generates the prediction image by using these coding parameters.

The coding parameter determination unit 110 calculates, for each of the multiple sets, an RD cost value indicating the magnitude of an amount of information and a coding error. The RD cost value is, for example, the sum of a code amount and the value obtained by multiplying a coefficient λ by a square error. The code amount is an amount of information of the coding stream Te obtained by performing entropy coding on a quantization error and a coding parameter. The square error is the sum of prediction errors calculated in the subtraction unit 102. The coefficient 2 is a real number greater than a preconfigured zero. The coding parameter determination unit 110 selects a set of coding parameters of which cost value calculated is a minimum value. The coding parameter determination unit 110 outputs the determined coding parameters to the parameter coder 111 and the prediction parameter derivation unit 120.

Note that a computer may be used to implement some of the video coding apparatus 11 and the video decoding apparatus 31 in the above-described embodiments, for example, the entropy decoder 301, the parameter decoder 302, the loop filter 305, the prediction image generation unit 308, the inverse quantization and inverse transform processing unit 311, the addition unit 312, the prediction parameter derivation unit 320, the prediction image generation unit 101, the subtraction unit 102, the transform and quantization unit 103, the entropy coder 104, the inverse quantization and inverse transform processing unit 105, the loop filter 107, the coding parameter determination unit 110, a parameter coder 111, and the prediction parameter derivation unit 120. In that case, this configuration may be realized by recording a program for realizing such control functions on a computer-readable recording medium and causing a computer system to read the program recorded on the recording medium for execution. Note that the “computer system” mentioned here refers to a computer system built into either the video coding apparatus 11 or the video decoding apparatus 31 and is assumed to include an OS and hardware components such as a peripheral apparatus. Furthermore, a “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium that dynamically retains a program for a short period of time, such as a communication line in a case that the program is transmitted over a network such as the Internet or over a communication line such as a telephone line, and may also include a medium that retains the program for a fixed period of time, such as a volatile memory included in the computer system functioning as a server or a client in such a case. Furthermore, the above-described program may be one for realizing some of the above-described functions, and also may be one capable of realizing the above-described functions in combination with a program already recorded in a computer system.

Furthermore, a part or all of the video coding apparatus 11 and the video decoding apparatus 31 in the embodiment described above may be realized as an integrated circuit such as a Large Scale Integration (LSI). Each function block of the video coding apparatus 11 and the video decoding apparatus 31 may be individually realized as processors, or part or all may be integrated into processors. The circuit integration technique is not limited to LSI, and the integrated circuits for the functional blocks may be realized as dedicated circuits or a multi-purpose processor. In a case that with advances in semiconductor technology, a circuit integration technology with which an LSI is replaced appears, an integrated circuit based on the technology may be used.

The embodiment of the present invention has been described in detail above referring to the drawings, but the specific configuration is not limited to the above embodiment and various amendments can be made to a design that fall within the scope that does not depart from the gist of the present invention.

### Application Examples

The above-mentioned video coding apparatus 11 and the video decoding apparatus 31 can be utilized being installed to various apparatuses performing transmission, reception, recording, and regeneration of videos. Note that, the video may be a natural video imaged by camera or the like, or may be an artificial video (including CG and GUI) generated by computer or the like.

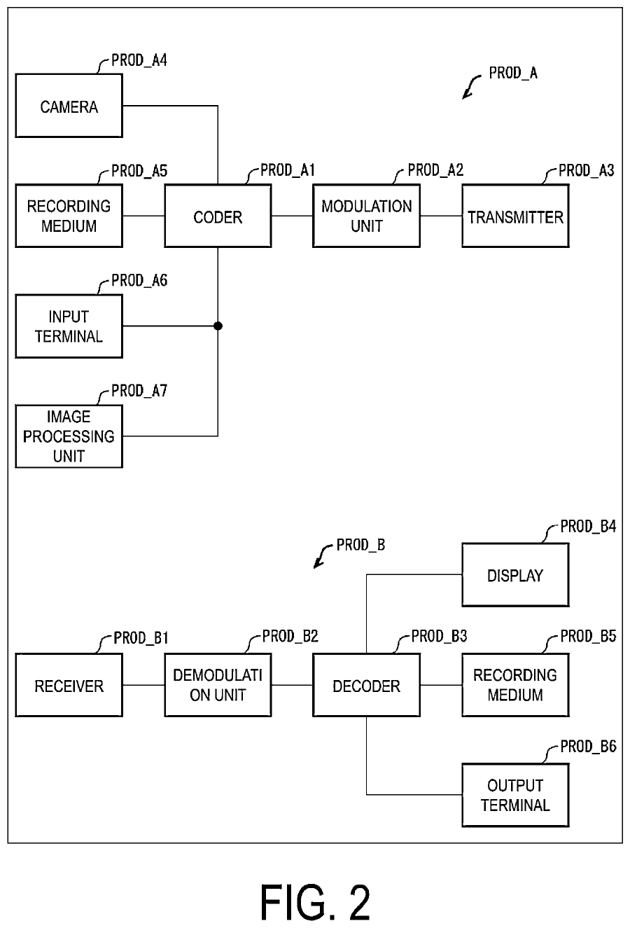

At first, referring to FIG. 2, it will be described that the above-mentioned video coding apparatus 11 and the video decoding apparatus 31 can be utilized for transmission and reception of videos.

FIG. 2(a) is a block diagram illustrating a configuration of a transmitting apparatus PROD_A installed with the video coding apparatus 11. As illustrated in FIG. 2(a), the transmitting apparatus PROD_A includes a coder PROD_A1 which obtains coded data by coding videos, a modulation unit PROD_A2 which obtains modulation signals by modulating carrier waves with the coded data obtained by the coder PROD_A1, and a transmitter PROD_A3 which transmits the modulation signals obtained by the modulation unit PROD_A2. The above-mentioned video coding apparatus 11 is utilized as the coder PROD_A1.

The transmitting apparatus PROD_A may further include a camera PROD_A4 that images videos, a recording medium PROD_A5 that records videos, an input terminal PROD_A6 for inputting videos from the outside, and an image processing unit A7 which generates or processes images, as supply sources of videos to be input into the coder PROD_A1. Although an example configuration in which the transmitting apparatus PROD_A includes all of the constituents is illustrated in the diagram, some of the constituents may be omitted.

Note that the recording medium PROD_A5 may record videos which are not coded or may record videos coded in a coding scheme for recording different from a coding scheme for transmission. In the latter case, a decoder (not illustrated) to decode coded data read from the recording medium PROD_A5 according to the coding scheme for recording may be present between the recording medium PROD_A5 and the coder PROD_A1.

FIG. 2(b) is a block diagram illustrating a configuration of a receiving apparatus PROD_B installed with the video decoding apparatus 31. As illustrated in the diagram, the receiving apparatus PROD_B includes a receiver PROD_B1 that receives modulation signals, a demodulation unit PROD_B2 that obtains coded data by demodulating the modulation signals received by the receiver PROD_B1, and a decoder PROD_B3 that obtains videos by decoding the coded data obtained by the demodulation unit PROD_B2. The above-mentioned video decoding apparatus 31 is utilized as the decoder PROD_B3.

The receiving apparatus PROD_B may further include a display PROD_B4 that displays videos, a recording medium PROD_B5 for recording the videos, and an output terminal PROD_B6 for outputting the videos to the outside, as supply destinations of the videos to be output by the decoder PROD_B3. Although an example configuration that the receiving apparatus PROD_B includes all of the constituents is illustrated in the diagram, some of the constituents may be omitted.

Note that the recording medium PROD_B5 may record videos which are not coded, or may record videos which are coded in a coding scheme for recording different from a coding scheme for transmission. In the latter case, a coder (not illustrated) that codes videos acquired from the decoder PROD_B3 according to the coding scheme for recording may be present between the decoder PROD_B3 and the recording medium PROD_B5.

Note that a transmission medium for transmitting the modulation signals may be a wireless medium or may be a wired medium. In addition, a transmission mode in which the modulation signals are transmitted may be a broadcast (here, which indicates a transmission mode in which a transmission destination is not specified in advance) or may be a communication (here, which indicates a transmission mode in which a transmission destination is specified in advance). That is, the transmission of the modulation signals may be realized by any of a wireless broadcast, a wired broadcast, a wireless communication, and a wired communication.

For example, a broadcasting station (e.g., broadcasting equipment)/receiving station (e.g., television receiver) for digital terrestrial broadcasting is an example of the transmitting apparatus PROD_A/receiving apparatus PROD_B for transmitting and/or receiving the modulation signals in the wireless broadcast. In addition, a broadcasting station (e.g., broadcasting equipment)/receiving station (e.g., television receivers) for cable television broadcasting is an example of the transmitting apparatus PROD_A/receiving apparatus PROD_B for transmitting and/or receiving the modulation signals in the wired broadcast.

In addition, a server (e.g., workstation)/client (e.g., television receiver, personal computer, smartphone) for Video On Demand (VOD) services, video hosting services and the like using the Internet is an example of the transmitting apparatus PROD_A/receiving apparatus PROD_B for transmitting and/or receiving the modulation signals in communication (usually, any of a wireless medium or a wired medium is used as a transmission medium in LAN, and the wired medium is used as a transmission medium in WAN). Here, personal computers include a desktop PC, a laptop PC, and a tablet PC. In addition, smartphones also include a multifunctional mobile telephone terminal.

A client of a video hosting service has a function of coding a video imaged with a camera and uploading the video to a server, in addition to a function of decoding coded data downloaded from a server and displaying on a display. Thus, the client of the video hosting service functions as both the transmitting apparatus PROD_A and the receiving apparatus PROD_B.

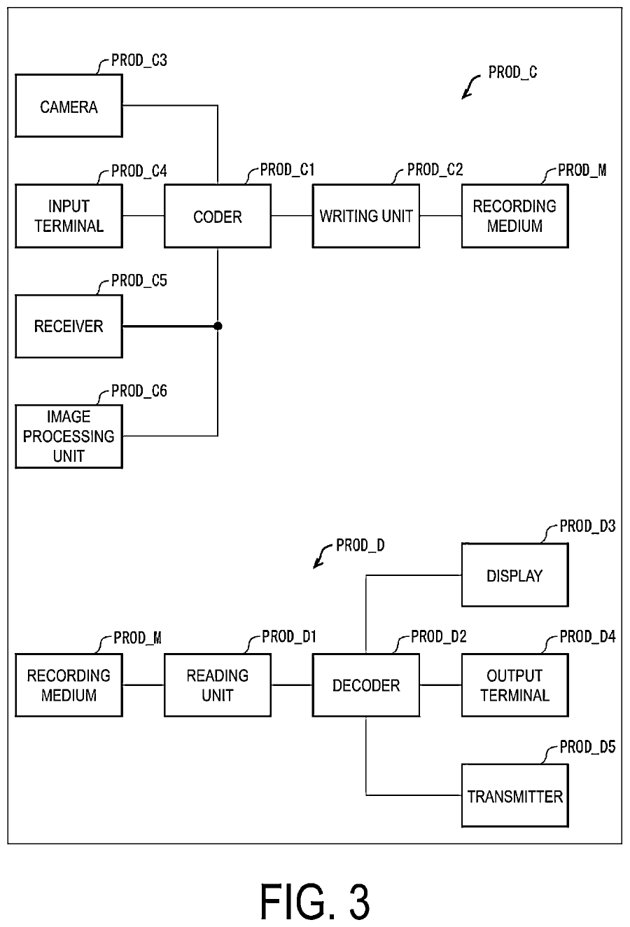

Next, referring to FIG. 3, it will be described that the above-mentioned video coding apparatus 11 and the video decoding apparatus 31 can be utilized for recording and regeneration of videos.

FIG. 3(a) is a block diagram illustrating a configuration of a recording apparatus PROD_C installed with the above-mentioned video coding apparatus 11. As illustrated in FIG. 3(a), the recording apparatus PROD_C includes a coder PROD_C1 that obtains coded data by coding a video, and a writing unit PROD_C2 that writes the coded data obtained by the coder PROD_C1 in a recording medium PROD_M. The above-mentioned video coding apparatus 11 is utilized as the coder PROD_C1.

Note that the recording medium PROD_M may be (1) a type of recording medium built in the recording apparatus PROD_C such as Hard Disk Drive (HDD) or Solid State Drive (SSD), may be (2) a type of recording medium connected to the recording apparatus PROD_C such as an SD memory card or a Universal Serial Bus (USB) flash memory, and may be (3) a type of recording medium loaded in a drive apparatus (not illustrated) built in the recording apparatus PROD_C such as Digital Versatile Disc (DVD: trade name) or Blu-ray Disc (BD: trade name).

In addition, the recording apparatus PROD_C may further include a camera PROD_C3 that images a video, an input terminal PROD_C4 for inputting the video from the outside, a receiver PROD_C5 for receiving the video, and an image processing unit PROD_C6 that generates or processes images, as supply sources of the video input into the coder PROD_C1. Although an example configuration that the recording apparatus PROD_C includes all of the constituents is illustrated in the diagram, some of the constituents may be omitted.

Note that the receiver PROD_C5 may receive a video which is not coded, or may receive coded data coded in a coding scheme for transmission different from the coding scheme for recording. In the latter case, a decoder for transmission (not illustrated) that decodes coded data coded in the coding scheme for transmission may be present between the receiver PROD_C5 and the coder PROD_C1.

Examples of such recording apparatus PROD_C include, for example, a DVD recorder, a BD recorder, a Hard Disk Drive (HDD) recorder, and the like (in this case, the input terminal PROD_C4 or the receiver PROD_C5 is the main supply source of videos). In addition, a camcorder (in this case, the camera PROD_C3 is the main supply source of videos), a personal computer (in this case, the receiver PROD_C5 or the image processing unit C6 is the main supply source of videos), a smartphone (in this case, the camera PROD_C3 or the receiver PROD_C5 is the main supply source of videos), or the like is an example of the recording apparatus PROD_C as well.

FIG. 3(b) is a block illustrating a configuration of a reconstruction apparatus PROD_D installed with the above-mentioned video decoding apparatus 31. As illustrated in the diagram, the reconstruction apparatus PROD_D includes a reading unit PROD_D1 which reads coded data written in the recording medium PROD_M, and a decoder PROD_D2 which obtains a video by decoding the coded data read by the reading unit PROD_D1. The above-mentioned video decoding apparatus 31 is utilized as the decoder PROD_D2.

Note that the recording medium PROD_M may be (1) a type of recording medium built in the reconstruction apparatus PROD_D such as HDD or SSD, may be (2) a type of recording medium connected to the reconstruction apparatus PROD_D such as an SD memory card or a USB flash memory, and may be (3) a type of recording medium loaded in a drive apparatus (not illustrated) built in the reconstruction apparatus PROD_D such as a DVD or a BD.

In addition, the reconstruction apparatus PROD_D may further include a display PROD_D3 that displays a video, an output terminal PROD_D4 for outputting the video to the outside, and a transmitter PROD_D5 that transmits the video, as the supply destinations of the video to be output by the decoder PROD_D2. Although an example configuration that the reconstruction apparatus PROD_D includes all of the constituents is illustrated in the diagram, some of the constituents may be omitted.

Note that the transmitter PROD_D5 may transmit a video which is not coded or may transmit coded data coded in the coding scheme for transmission different from a coding scheme for recording. In the latter case, a coder (not illustrated) that codes a video in the coding scheme for transmission may be present between the decoder PROD_D2 and the transmitter PROD_D5.

Examples of the reconstruction apparatus PROD_D include, for example, a DVD player, a BD player, an HDD player, and the like (in this case, the output terminal PROD_D4 to which a television receiver, and the like are connected is the main supply destination of videos). In addition, a television receiver (in this case, the display PROD_D3 is the main supply destination of videos), a digital signage (also referred to as an electronic signboard or an electronic bulletin board, and the like, and the display PROD_D3 or the transmitter PROD_D5 is the main supply destination of videos), a desktop PC (in this case, the output terminal PROD_D4 or the transmitter PROD_D5 is the main supply destination of videos), a laptop or tablet PC (in this case, the display PROD_D3 or the transmitter PROD_D5 is the main supply destination of videos), a smartphone (in this case, the display PROD_D3 or the transmitter PROD_D5 is the main supply destination of videos), or the like is an example of the reconstruction apparatus PROD_D.

### Realization by Hardware and Realization by Software

Each block of the above-mentioned video decoding apparatus 31 and the video coding apparatus 11 may be realized as a hardware by a logical circuit formed on an integrated circuit (IC chip), or may be realized as a software using a Central Processing Unit (CPU).

In the latter case, each of the above-described apparatuses includes a CPU that executes a command of a program to implement each of functions, a Read Only Memory (ROM) that stores the program, a Random Access Memory (RAM) to which the program is loaded, and a storage apparatus (recording medium), such as a memory, that stores the program and various kinds of data. In addition, an objective of the embodiment of the present invention can be achieved by supplying, to each of the apparatuses, the recording medium that records, in a computer readable form, program codes of a control program (executable program, intermediate code program, source program) of each of the apparatuses that is software for realizing the above-described functions and by reading and executing, by the computer (or a CPU or an MPU), the program codes recorded in the recording medium.

As the recording medium, for example, tapes including a magnetic tape, a cassette tape and the like, discs including a magnetic disc such as a floppy (trade name) disk/a hard disk and an optical disc such as a Compact Disc Read-Only Memory (CD-ROM)/Magneto-Optical disc (MO disc)/Mini Disc (MD)/Digital Versatile Disc (DVD: trade name)/CD Recordable (CD-R)/Blu-ray Disc (trade name), cards such as an IC card (including a memory card)/an optical card, semiconductor memories such as a mask ROM/Erasable Programmable Read-Only Memory (EPROM)/Electrically Erasable and Programmable Read-Only Memory (EEPROM: trade name)/a flash ROM, logical circuits such as a Programmable logic device (PLD) and a Field Programmable Gate Array (FPGA), or the like can be used.

In addition, each of the apparatuses is configured to be connectable to a communication network, and the program codes may be supplied through the communication network. The communication network is required to be capable of transmitting the program codes, but is not limited to a particular communication network. For example, the Internet, an intranet, an extranet, a Local Area Network (LAN), an Integrated Services Digital Network (ISDN), a Value-Added Network (VAN), a Community Antenna television/Cable Television (CATV) communication network, a Virtual Private Network, a telephone network, a mobile communication network, a satellite communication network, and the like are available. In addition, a transmission medium constituting this communication network is also required to be a medium which can transmit a program code, but is not limited to a particular configuration or type of transmission medium. For example, a wired transmission medium such as Institute of Electrical and Electronic Engineers (IEEE) 1394, a USB, a power line carrier, a cable TV line, a telephone line, an Asymmetric Digital Subscriber Line (ADSL) line, and a wireless transmission medium such as infrared ray of Infrared Data Association (IrDA) or a remote control, BlueTooth (trade name), IEEE 802.11 wireless communication, High Data Rate (HDR), Near Field Communication (NFC), Digital Living Network Alliance (DLNA: trade name), a cellular telephone network, a satellite channel, a terrestrial digital broadcast network are available. Note that the embodiment of the present invention can be also realized in the form of computer data signals embedded in a carrier such that the transmission of the program codes is embodied in electronic transmission.

The embodiment of the present invention is not limited to the above-described embodiment, and various modifications are possible within the scope of the claims. That is, an embodiment obtained by combining technical means modified appropriately within the scope defined by claims is included in the technical scope of the present invention as well.

### INDUSTRIAL APPLICABILITY

The embodiment of the present invention can be preferably applied to a video decoding apparatus that decodes coded data in which image data is coded, and a video coding apparatus that generates coded data in which image data is coded. The embodiment of the present invention can be preferably applied to a data structure of coded data generated by the video coding apparatus and referred to by the video decoding apparatus.

### CONCLUSION

An image decoding apparatus according to an aspect of the present invention includes a parameter decoder that decodes a parameter for generating a prediction image, and in a case that a regular merge flag indicates a regular merge mode, checks a flag indicating whether an MMVD prediction signalled in the sequence parameter set or the like is available, and in a case that the MMVD prediction is not available, decodes motion vector information obtained from a merge candidate.

An image decoding apparatus according to an aspect of the present invention decodes, in a case that the regular merge flag indicates the regular merge mode, a flag sps_mmvd_enabled_flag indicating whether the MMVD prediction signalled in the sequence parameter set or the like is available, and a flag mmvd_merge_flag indicating whether the MMVD prediction is used in CU units, and in a case that mmvd_merge_flag==0 or sps_mmvd_enabled_flag==0 and that the number of merge candidates MaxNumMergeCand is greater than 1, the parameter decoder decodes an index merge_idx for selection from merge candidates as the motion vector information.

An image coding apparatus according to an aspect of the present invention includes parameter coding for coding a parameter for generating a prediction image, and in a case that a regular merge flag indicates a regular merge mode, checks a flag indicating whether an MMVD prediction signalled in the sequence parameter set or the like is available, and in a case that the MMVD prediction is not available, decodes motion vector information obtained from a merge candidate.

The image coding apparatus according to an aspect of the present invention codes, in a case that the regular merge flag indicates the regular merge mode, a flag sps_mmvd_enabled_flag indicating whether the MMVD prediction signalled in the sequence parameter set or the like is available, and a flag mmvd_merge_flag indicating whether the MMVD prediction is used in CU units, and in a case that mmvd_merge_flag==0 or sps_mmvd_enabled_flag==0 and that the number of merge candidates MaxNumMergeCand is greater than 1, the parameter coder codes an index merge_idx for selection from merge candidates as the motion vector information.

With such a configuration, even in a case that the MMVD mode is inhibited by an upper syntax, the merge mode can be selectively used, thus achieving high coding efficiency.

An aspect of the present invention provides an image decoding apparatus configured to decode a parameter for generating a prediction image, the image decoding apparatus including a parameter decoder configured to decode, from merge data, a regular merge flag indicating whether a regular merge mode is used for inter prediction, wherein the parameter decoder is configured to check, in a case that the regular merge flag indicates that the regular merge mode is used for inter prediction, a flag indicating whether a motion vector for a merge candidate signalled in a sequence parameter set is enabled, to decode, in a case that the flag has a value of 1, an MMVD merge flag indicating whether the motion vector for the merge candidate is used to generate an inter prediction parameter of a target coding unit, and to use the MMVD merge flag to decode a merge index corresponding to an index for a merge candidate list.

In the image decoding apparatus according to an aspect of the present invention, the merge index is decoded in a case that the MMVD merge flag indicates that the motion vector for the merge candidate is not used to generate the inter prediction parameter and that a number of merge candidates is greater than 1.

In the image decoding apparatus according to an aspect of the present invention, in a case that the MMVD merge flag has a value of 0, a value of the merge index is inferred to be 0.

An aspect of the present invention provides an image coding apparatus for coding a parameter for generating a prediction image, the image coding apparatus including a parameter coder configured to code, from merge data, a regular merge flag indicating whether a regular merge mode is used for inter prediction, wherein the parameter coder checks a flag, in a case that the regular merge flag indicates that the regular merge mode is used for inter prediction, indicating whether or not a motion vector for a merge candidate signalled in a sequence parameter set is enabled, codes, in a case that the flag has a value of 1, an MMVD merge flag indicating whether or not the motion vector for the merge candidate is used to generate an inter prediction parameter of a target coding unit, and uses the MMVD merge flag to code a merge index corresponding to an index of a merge candidate list.

An aspect of the present invention provides an image decoding method for decoding a parameter for generating a prediction image, the image decoding method at least including the steps of: decoding, from merge data, a regular merge flag indicating whether a regular merge mode is used for inter prediction; checking a flag, in a case that the regular merge flag indicates that the regular merge mode is used for inter prediction, indicating whether or not a motion vector for a merge candidate signalled in a sequence parameter set is enabled; decoding, in a case that the flag has a value of 1, an MMVD merge flag indicating whether or not the motion vector for the merge candidate is used to generate an inter prediction parameter of a target coding unit; and using the MMVD merge flag to decode a merge index corresponding to an index of a merge candidate list.

### CROSS-REFERENCE OF RELATED APPLICATION

This international application claims priority to JP 2019-135746, filed on Jul. 24, 2019, and the total contents thereof are hereby incorporated by reference.

### REFERENCE SIGNS LIST

31 Image decoding apparatus
301 Entropy decoder
302 Parameter decoder
303 Inter prediction parameter derivation unit
304 Intra prediction parameter derivation unit
305, 107 Loop filter
306, 109 Reference picture memory
307, 108 Prediction parameter memory
308, 101 Prediction image generation unit
309 Inter prediction image generation unit
310 Intra prediction image generation unit
311, 105 Inverse quantization and inverse transform processing unit
312, 106 Addition unit
320 Prediction parameter derivation unit
11 Image coding apparatus
102 Subtraction unit
103 Transform and quantization unit
104 Entropy coder
110 Coding parameter determination unit
111 Parameter coder
112 Inter prediction parameter coder
113 Intra prediction parameter coder
120 Prediction parameter derivation unit

1: An image decoding apparatus for decoding a parameter for generating a prediction image, the image decoding apparatus comprising:
a parameter decoding circuit configured to decode, from merge data, a regular merge flag indicating whether a regular merge mode is used in inter prediction, decode, from the merge data, an MMVD merge flag indicating whether or not an MMVD mode is used to generate an inter prediction parameter of a target coding unit, and decode, from the merge data, a merge index which is an index of a merge candidate list, wherein
the parameter decoding circuit
checks an MMVD enabled flag, signalled in a sequence parameter set, indicating whether or not the MMVD mode is enabled in a case that a value of the regular merge flag is 1,
decodes the MMVD merge flag in a case that a value of the MMVD enabled flag is 1,
infers the MMVD merge flag in a case that a value of the MMVD enabled flag is 0,
decodes the merge index in a case that the value of the MMVD enabled flag is 0 and a number of merge candidates is greater than 1, and
infers the merge index in a case that the value of the MMVD enabled flag is 0 and a number of merge candidates is less than or equal to 1.

2. (canceled)

3: The image decoding apparatus according to claim 1, wherein, in a case that a value of the MMVD merge flag is 0 and the number of merge candidates is less than or equal to 1, the parameter decoding circuit infers a value of the merge index equal to 0.

4. (canceled)

5: An image decoding method for decoding a parameter for generating a prediction image, the image decoding method at least comprising the steps of:
decoding, from merge data, a regular merge flag indicating whether a regular merge mode is used for inter prediction;
checking an MMVD enabled flag, signalled in a sequence parameter set, indicating whether or not an MMVD mode is enabled in a case that a value of the regular merge flag is 1;
decoding, from the merge data, an MMVD merge flag indicating whether or not the MMVD mode is used to generate an inter prediction parameter of a target coding unit in a case that a value of the MMVD enabled flag is 1;
inferring the MMVD merge flag in a case that a value of the MMVD enabled flag is 0;
decoding, from the merge data, a merge index which is an index of a merge candidate list in a case that the MMVD enabled flag is 0 and a number of merge candidates is greater than 1; and
inferring the merge index in a case that the value of the MMVD enabled flag is 0 and a number of merge candidates is less than or equal to 1.
